(19) United States
(12) Patent Application Publication
(10) Pub. No.: US 2017/0353763 A1
(43) Pub. Date: Dec. 7, 2017

(54) BEHAVIOR MANAGEMENT SYSTEM, BEHAVIOR MANAGEMENT METHOD, AND INFORMATION PROCESSING APPARATUS

(71) Applicant: Kenichi OZAWA, Kanagawa (JP)

(72) Inventor: Kenichi OZAWA, Kanagawa (JP)

(21) Appl. No.: 15/602,430

(22) Filed: May 23, 2017

(30) Foreign Application Priority Data
Jun. 2, 2016 (JP) 2016-110682

(51) Int. Cl. H04N 21/442; H04N 21/422; H04N 21/45; E04H 3/30

(52) U.S. Cl. CPC H04N 21/44218; H04N 21/4524; H04N 21/42202; E04H 3/30

(57) ABSTRACT

A behavior management system includes one detection apparatus including at least one piezoelectric element diposed at a place where the piezoelectric element receives an effect of an action of a person, and circuitry. The circuitry detects a voltage output from the piezoelectric element when the piezoelectric element is applied with force caused by the action of the person, determines a level of the action of the person at the place based on a change of amplitude and polarity of the detected voltage, and outputs information associated to the determined level of the action of the person.

### CROSS-REFERENCE TO RELATED APPLICATION

This application claims priority pursuant to 35 U.S.C. §119(a) to Japanese Patent Application No. 2016-10682, filed on Jun. 2, 2016 in the Japan Patent Office, the disclosure of which is incorporated by reference herein in its entirety.

### BACKGROUND

### Technical Field

This disclosure relates to a behavior management system a behavior management method, an information processing apparatus, and a storage medium.

### Background Art

When audience jumps at an event venue such as a concert, shaking sounds like an earthquake occurs in an area such as a hall. Further, the audience may perform excessive movement such as jumping, stepping foot, and left and right movement, which may become dangerous actions, and the excessive movement may annoy other audiences because the sight of audiences is obstructed by such action. Conventionally, the audience monitoring using monitoring cameras is conducted to identify audiences that perform dangerous actions. However, when people are crowded and the looking is bad, the audience monitoring using the monitoring cameras cannot be conducted effectively.

### SUMMARY

As one aspect of present disclosure, a behavior management system is devised. The behavior management system includes one detection apparatus including at least one piezoelectric element disposed at a place where the piezoelectric element receives an effect of an action of a person, and circuitry. The circuitry detects a voltage output from the piezoelectric element when the piezoelectric element is applied with force caused by rite action of the person, determines a level of the action of the person at the place based on a change of amplitude and polarity of the detected voltage, and outputs information associated to the determined level of the action of the person.

As another aspect of present disclosure, a method of monitoring behavior of a person is devised. The method includes receiving an effect of an action of the person present at a place by using a piezoelectric element disposed at the place, detecting a voltage output from the piezoelectric element when the piezoelectric element is applied with force caused by the actions of the person, determining a level of the action of the person at the place based on a change of amplitude and polarity of the detected voltage, and outputting information associated to the determined level of the action of the person.

As another aspect of present disclosure, an information processing apparatus is devised. The information processing apparatus includes circuitry to detect a voltage output front a detection apparatus including a piezoelectric element, disposed at a place where a person is present, when the piezoelectric element is applied with force caused by an action of the person, determine a level of the action of the person at the place based on a change of amplitude avid polarity of the detected voltage, and output information associated to the determined level of the action of the person.

### BRIEF DESCRIPTION OF THE DRAWINGS

A more complete appreciation of the description and many of the attendant advantages and features thereof can be readily obtained and understood from the following detailed description with reference to the accompanying drawings, wherein:

FIG. 1 is an example of a schematic configuration of a behavior management system of a first embodiment;

FIG. 2 illustrates an example of a hardware block diagram of an information processing apparatus of the first embodiment;

FIG. 3 illustrates an example of a hardware block diagram of a detection apparatus of the first embodiment;

FIG. 4 is an example of a functional block diagram of the information processing apparatus;

FIG. 5(A) illustrates an example of a seated person;

FIG. 5(B) illustrates an example of a standing person;

FIG. 5(C) illustrates an example of a jumping person;

FIG. 5(D) illustrates an example of a landing of person after jumping;

FIG. 6 illustrates examples of waveform of voltage output from an energy converting device;

FIG. 7 illustrates an example of a waveform of output voltage caused by a behavior of a person;

FIGS. 8A and 8B illustrate examples of a time-wise change of voltage waveform;

FIG. 9 is an example of a flow chart illustrating the steps of a determination process of the first embodiment;

FIGS. 10A, 10B and 10C illustrate examples of screen images corresponding to behaviors of person displayed on a display;

FIG. 11 illustrates an example of an arrangement of a detection apparatus of a second embodiment;

FIG. 12 illustrates an example of a hardware block diagram of the detection apparatus of the second embodiment;

FIG. 13A illustrates an example of a waveform of voltage output from an energy converting device when a person sits on a seat, is sitting on the seat, and leaves from the seat;

FIG. 13B illustrates an example of a waveform of voltage output from an energy converting device when an object is to be placed on a seat, is being placed on the seat, and is displaced from the seat;

FIG. 14 is an example of a flow chart illustrating the steps of processing of the second embodiments;

FIG. 15 illustrates an example of transitions of seat condition detectable by using the detection apparatus of the second embodiment.

FIGS. 16A and 16B are an example of a flow chart illustrating the steps of a determination process of the second embodiment;

FIG. 17 illustrates a method of calculating a score of a monitored person;

FIG. 18 illustrates a method of calculating a score of surroundings of a monitored person;

FIG. 19 illustrates an example of a table correlating determination results of behavior of monitored person and scores.

FIG. 20 illustrates an example of display information of behavior of monitored person;

FIG. 21 illustrates an example of display information of behavior of monitored person displayed on a remote terminal device;

FIG. 22 illustrates an example of a functional block diagram of an information processing apparatus of a third embodiment;

FIG. 23 illustrates an example of setting a relatively smaller weight for each of persons in the same row of a monitored person;

FIG. 24 illustrates an example of setting of weight for each seat in a hall depending on positions of seats in the hall;

FIGS. 25A and 25B illustrate a process of excluding a score of a specific point from a calculation of a score of surroundings;

FIGS. 26A and 26B illustrate an example of changing of weight values depending on a change of viewing direction of audience;

FIG. 27 illustrates an example of changing weight values when a viewing direction is changed to a sub-stage set at the center of a hall;

FIG. 28 illustrates an example of a schematic cross-sectional view of an electricity generation element of an energy converting device;

FIG. 29 illustrates another example of a schematic cross-sectional view of an electricity generation element of an energy converting device;

FIG. 30 illustrates an example of a schematic enlarged cross-sectional view of a micro structure of an intermediate layer configuring an electricity generation element of an energy converting device;

FIG. 31 illustrates another example of a schematic enlarged cross-sectional view of a micro structure of another intermediate layer configuring an electricity generation element of an energy converting device;

FIG. 32 illustrates another example of a schematic enlarged cross-sectional view of a micro structure of another intermediate layer configuring an electricity generation element of an energy converting device;

FIG. 33 illustrates another example of a schematic enlarged cross-sectional view of a micro structure of another intermediate layer configuring art electricity generation element of an energy converting device;

FIG. 34 illustrates an example of a schematic cross-sectional view of an energy converting device; and

FIG. 35 illustrates another example of a schematic cross-sectional view of an energy converting device.

The accompanying drawings are intended to depict exemplary embodiment of the present invention and should not be interpreted to limit the scope thereof. The accompanying drawings are not to he considered as drawn to scale unless explicitly noted, and identical or similar reference numerals designate identical or similar components throughout the several views.

### DETAILED DESCRIPTION

A description is now given of exemplary embodiments of present disclosure, it should be noted that although such terms as first, second, etc. may be used herein to describe various elements, components, regions, lasers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of present disclosure.

In addition, it should be noted that the terminology used herein is for the purpose of describing particular embodiments only and is not intended to be limiting of present disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views illustrated in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more embodiments are described hereinafter.

Hereinafter, a description is given of embodiments of the present disclosure with reference to drawings. In this disclosure, components having the same or similar functional configuration among the embodiments of the present disclosure are assigned with the same references, and described by omitting the descriptions if redundant.

### First Embodiment

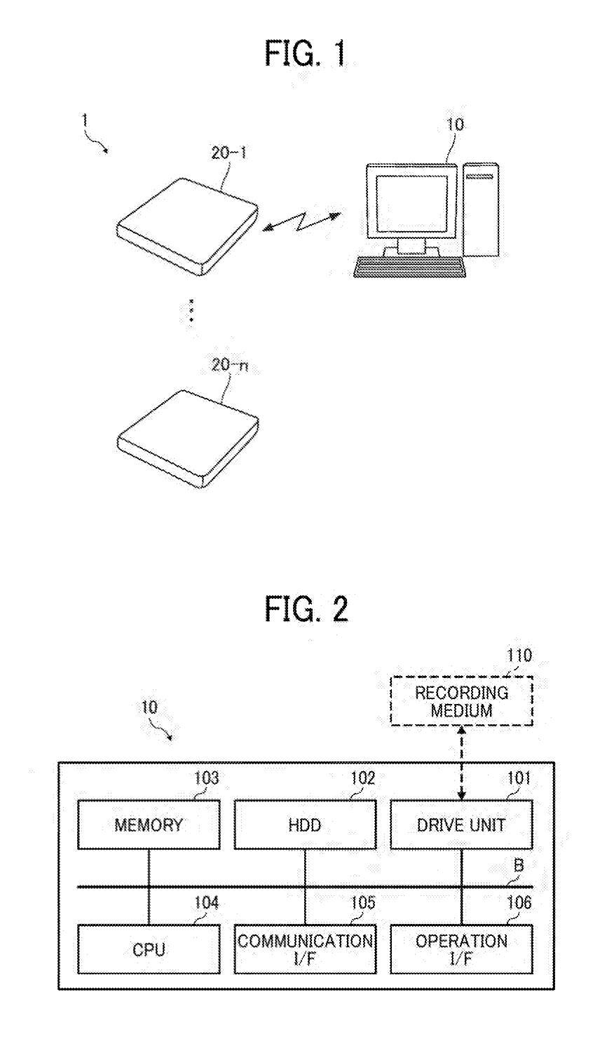

FIG. 1 is an example of a schematic configuration of a behavior management system 1 of a first embodiment. As illustrated in FIG. 1, the behavior management system 1 includes, for example, an information processing apparatus 10, and a plurality of detection apparatuses 20-1, 20-2, . . . 20-n. Hereinafter, the plurality of detection apparatuses 20-1 to 20-n may be collectively referred to as the detection apparatus 20 for the simplicity of the description.

The information processing apparatus 50 can be used to monitor and manage a behavior of a person (e.g. audience, user) present at each seat disposed with the detection apparatus 20, and the information processing apparatus 10 can be used to display various data including the behavior of person at each seat.

Specifically, the information processing apparatus 10 determines whether the behavior of person is a dangerous action. The dangerous action means excessive movement or action at each seat such as jumping, and stepping foot or the like. When the information processing apparatus 10 determines that the person performed or is performing the dangerous action, the information processing apparatus 10 displays information (e.g., graphic image, sound, text) indicating the dangerous action. Therefore, the behavior management system 1 can check or monitor the behavior of person based on a processing result of the information processing apparatus 10, and can be used to manage the behavior of person. In this description, the behavior of person means an action of at least one person.

Further, the information processing apparatus 10 can be connected with a terminal device (e.g., tablet terminal device, smart phone, wearable terminal device) via a communication network (e.g., the Internet, LAN, portable telephone line network) wirelessly or by wire. In this configuration, the information processing apparatus 10 can report the behavior of person at each seat to the terminal device via the communication network, in which the information processing apparatus 10 can use the terminal device as a display device to display information of the behavior of person on the terminal device.

The detection apparatus 20 is disposed, for example, at a foot of each seat to detect the behavior of person at each seat.

### (Hardware Block Diagram)

FIG. 2 illustrates an example of a hardware block diagram of the information processing, apparatus 10 of the first embodiment of the present disclosure.

The information processing apparatus 10 includes, for example, a drive unit 101, a hard disk drive (HDD)102, a memory 103, a central processing unit (CPU) 104, a communication interface (I/F) 105, an operation interface (I/F) 106, which are connected with each other via a bus B.

The HDD 102 stores programs installed for the information processing apparatus 10, and stores required files and data. The memory 103 reads programs from the HDD 102 when activating the information processing apparatus 10, and loads the read programs on the memory 103. The CPU 104 perform various processing to be described later by executing the programs loaded on the memory 103.

The communication I/F 105 includes, for example, a universal serial bus (USB) port, a wireless local area network (LAN) card, and a LAN card used for connecting the information processing apparatus 10 with a network.

The operation I/F 106 includes, for example, an input device such as a touch panel, a keyboard, a pointing device, and a remote controller, and a display such as a liquid crystal display (LCD) panel, an organic electroluminescent (OEL) display, and a head-up display. The display can display an operation screen used for operating the information processing apparatus 10.

In this disclosure, the behavior management system 1 can monitor a condition at each seat, to be described later, by executing one or more programs. The one or more programs can be provided by, for example, a distribution of a recording medium 110, and downloading from a network. The recording medium 110 can be various types of recording media such as a recording medium that can store information optically, electrically or magnetically (e.g., compact disc read only memory (CD-ROM), flexible disk, magneto-optical disk), a read only memory (ROM), and a semiconductor memory that stores information electrically such as a flash memory.

Further, when the recording medium 110 storing programs used for implementing the embodiments is set to the drive unit 101, the programs are installed in the HDD 102 from the recording medium 110 via the drive unit 101. When programs are downloaded from a network, the programs are installed in the HDD 102 via the communication I/F 105.

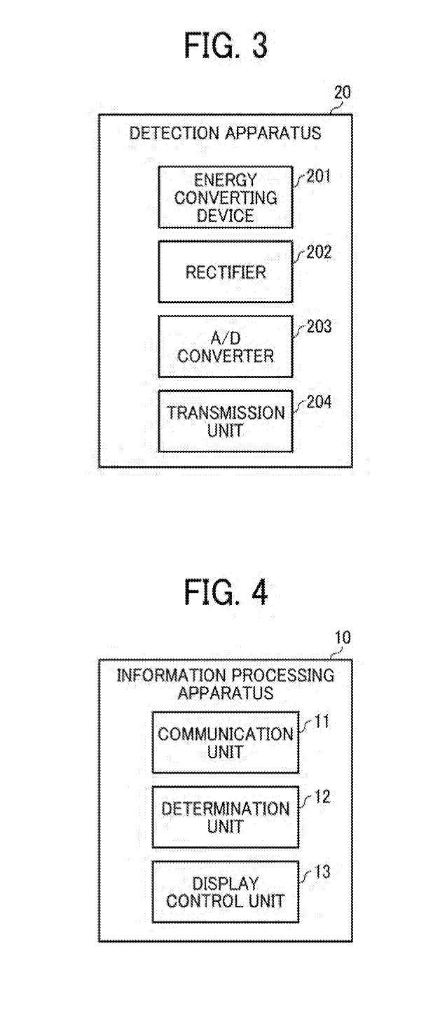

FIG. 3 illustrates an example of a hardware block diagram of the detection apparatus 20 of the first embodiment. As illustrated in FIG. 3, the detection apparatus 20 includes, for example, an energy converting device 201, a rectifier 202, an analog/digital (A/D) converter 203, and a transmission unit 204.

The energy converting device 201 is disposed at, for example, a surface (e.g., ground, floor) in front of a seat to detect a load of a person applied to the surface. Specifically, the energy converting device 201 detect a load of a person applied to the surface when the person stands up from the seat, and moves the foot.

The energy converting device 201 is, for example, a passive element such as a piezoelectric element that uses the piezoelectric effect. The piezoelectric element converts force applied to piezoelectric material to voltage. The piezoelectric element is made of material that can implement the embodiments of this disclosure such as an electricity generation rubber, and ceramics. The electricity generation rubber includes a transducer, which is an electricity generation element made of elastic material and having capability of converting pressure to an electric signal. Therefore, when the electricity generation rubber deforms, the electrical potential of the electricity generation rubber changes according to the degree of deformation of the electricity generation rubber, and further, the polarity of electrical potential changes of the electricity generation rubber between positive and negative potentials according to the direction that force is applied to the electricity generation rubber.

Further, the energy converting device 201 can be manufactured, for example, by using piezoelectric material having unevenly set polarization in the material, and a friction-use electricity generation element that generates electricity by using peeling electrification causable by charged condition difference of material.

To be described later in this description, the energy converting device 201 can be configured to detect electrical signals corresponding to electromagnetic (EM) noise such as electromagnetic wave noise. Specifically, when a person (human body) exists on or near the energy converting device 201, the electromagnetic (EM) noise is received by the human body, in which the human body functions as an antenna to receive the electromagnetic (EM) noise, and then the energy converting device 201 detects electrical signals corresponding to the electromagnetic (EM) noise received via the human body. Since an organic body such as the human body is electrically conductive, the human body receives electromagnetic waves radiated from surrounding electronic apparatuses by using the human body as the antenna. Therefore, the energy converting device 201 detects the electromagnetic waves via the human body, and outputs the detected electromagnetic waves as electrical signals. The detailed example of the energy converting device 201 that detects electrical signals corresponding to electromagnetic (EM) noise will be described later.

The rectifier 202 and the A/D converter 203 quantize waveform of voltage of the electric signals, output by the energy converting device 201, and converts the waveform of voltage of the electric signal into digital data indicating values of the voltage waveform.

The transmission unit 204 transmits the digital data indicating the values of the voltage waveform, converted by the A/D converter 203, o the information processing apparatus 10 by using a line or network such as local area network (LAN), wireless LAN, and a universal serial bus (USB) cable.

### (Functional Block Diagram of Information Processing Apparatus)

A description is given of a functional block diagram of the information processing apparatus 10 with reference to FIG. 4. FIG. 4 is an example of a functional block diagram of the information processing apparatus 10. The information processing apparatus 10 includes, for example, a communication unit 11, a determination unit 12, and a display control unit 13. Each of the communication unit 11, the determination unit 12, and the display control unit 13 can be implemented when the CPU 104 of the information processing apparatus 10 executes one or more programs installed in the information processing apparatus 10.

The communication unit 11 receives the waveform data of voltage output from the energy converting device 201 from the detection apparatus 20.

The determination unit 12 determines the behavior of person at each seat disposed with the detection apparatus 20 based on the waveform data of voltage acquired from the detection apparatus 20.

The display control unit 13 displays the behavior of person (e.g. audience) determined by the determination unit 12 on a screen of the information processing apparatus 10 or other terminal device. Further, the behavior of person (e.g. audience) determined by the determination unit 12 can be reported to the information processing apparatus 100 or other terminal device by using sound and/or vibration.

### (Waveform of Voltage)

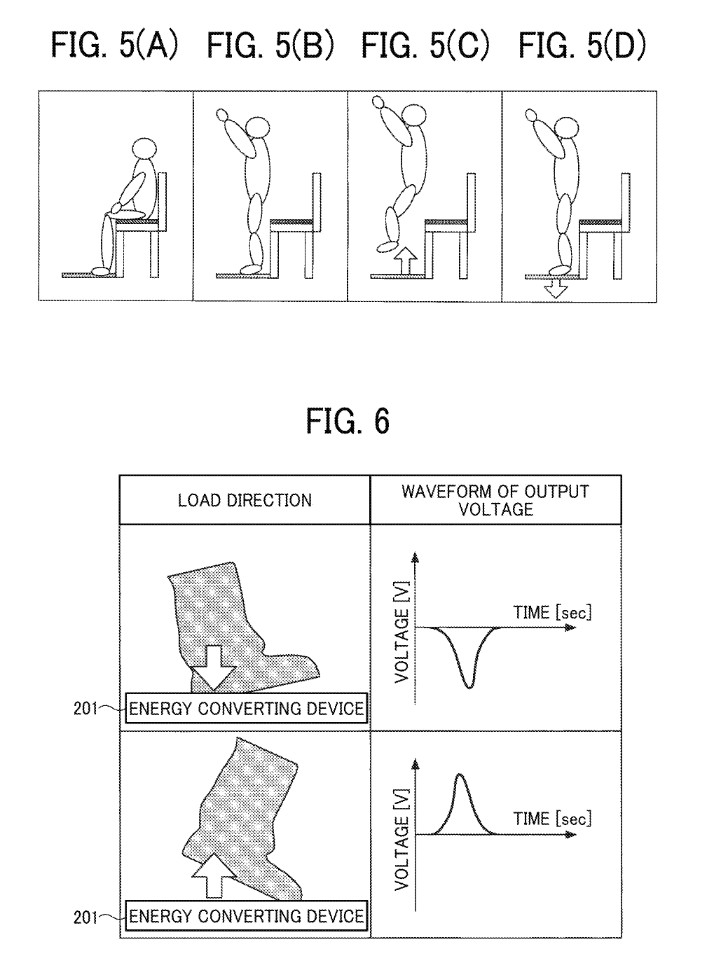

A description is given of examples waveforms of voltage output from the energy converting device 201 of the detection apparatus 20 corresponding to the behavior of person (i.e., physical status of person) with reference to FIGS. 5 to 8.

FIG. 5 illustrate examples of behavior of person. FIG. 5(A) illustrates an example of a seated person, FIG. 5(B) illustrates an example of a standing person. FIG. 5(C) illustrates an example of a jumping person, and FIG. 5(D) illustrates an example of a landing of person after jumping.

A description is given of the waveform of voltage output from the energy converting device 201 with reference to FIG 6. As illustrated in FIG. 6, the potential of the energy converting device 201 such as the electricity generation rubber changes according to the degree of deformation of the energy converting device 201. Specifically, when a force is applied to the energy converting device 201 in a direction to push in the energy converting device 201, a negative voltage is generated, and when a force is applied in a direction leaving front the energy converting, device 201, a positive voltage is generated as illustrated in FIG. 6.

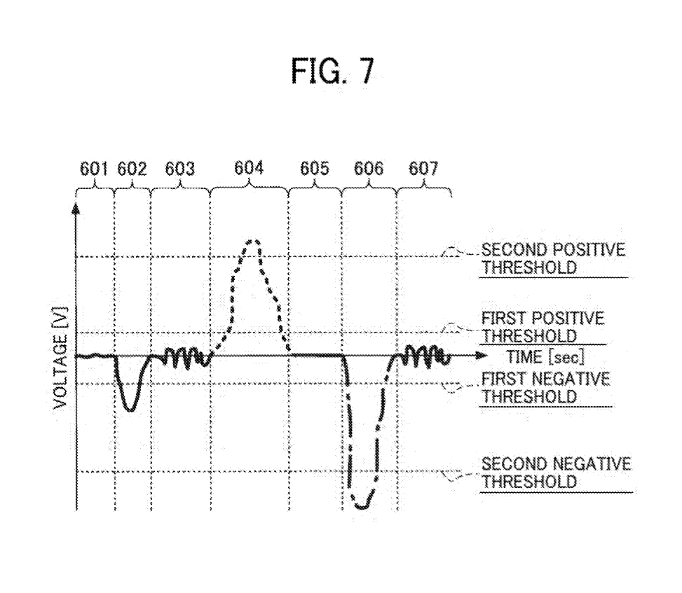

FIG. 7 illustrates an example of a waveform of output voltage caused by a behavior of a person.

When the person is seated on a seat (FIG. 5(A)), a force applied to a foot does not change so much. Therefore, the deformation of the electricity generation rubber becomes smaller, and thereby a voltage waveform 601 is output from the energy converting device 201.

As illustrated in FIGS. 5(A) to 5(B), when the person stands up (FIG. 5(B)) from the seated state (FIG. 5(A)), a vertical downward force is applied to the foot. Therefore, the electricity generation rubber deforms in the downward direction, and thereby a voltage waveform 602 is output from the energy converting device 201.

When the standing (FIG. 5(B)) is being continued, the voltage fluctuates between positive and negative values with setting a smaller range as indicated by a voltage waveform 603, in which the voltage waveform 603 having an amplitude smaller than an amplitude of the voltage waveform 602 is output from the energy converting device 201. Further, the transmission unit 204 of the detection apparatus 20 can be configured not to transmit specific waveform data such as the voltage waveform 603 to the information processing apparatus 10.

As illustrated in FIGS. 5(B) and 5(C), when the person jumps (FIG. 5(C)), the electricity generation rubber deforms in the returning direction (i.e., upward direction), and a voltage waveform 604 having a greater positive polarity is output from the energy converting device 201. Then, when the person is jumping and slaying in air as illustrated in FIG. 5(C), no force is applied to the foot, and thereby the electricity generation rubber does not deform, in which a voltage waveform 605 that is close to 0V is output from the energy converting device 201. Further, a relatively longer time is required to return from the deformation depending on material of the electricity generation rubber, in which the voltage waveform 605 may not be output.

As illustrated in FIGS. 5(C) and 5(D), when the person lands (FIG. 5(D)) after jumping, a voltage waveform 606 having an absolute value of the negative value, which is greater than an absolute value of the voltage waveform 602, is output from Use energy converting device 201.

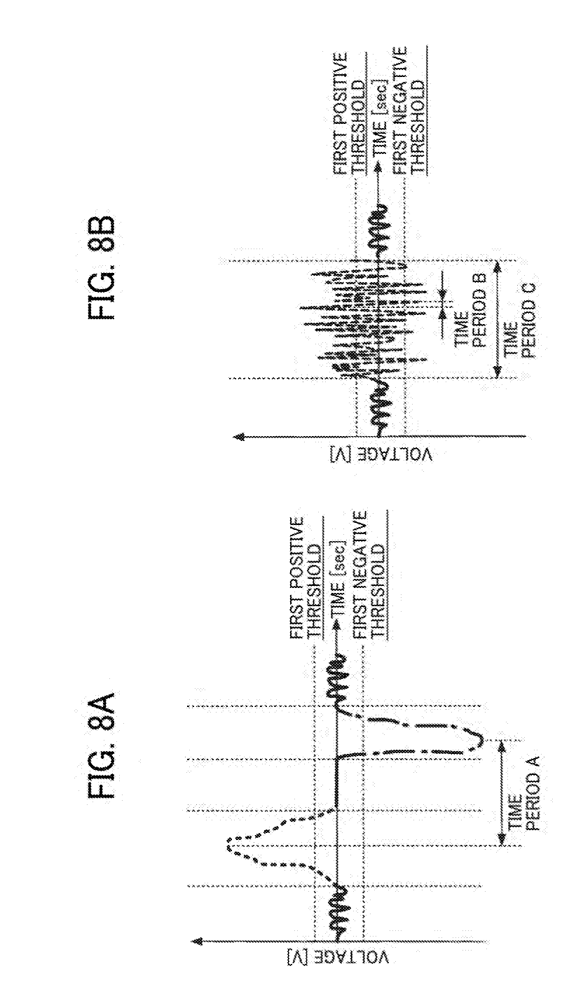

A description is given of examples of a time-wise change of voltage waveform with reference to FIG. 8. The time-wise change of voltage waveform may be also referred to as a changing pattern of voltage such as a changing pattern of polarity of the detected voltage along a time line.

FIG. 8A is an example of a waveform of voltage when a person jumps, similar to the voltage waveforms 603 to 607 in FIG. 7. In this example case, when a greater positive voltage is output and then it given time period (e.g., 0.5 to 2 seconds) elapses as indicated as a time period A in FIG. 8A, a greater negative voltage is output.

FIG. 8B is an example of a waveform of voltage when a person moves his/her foot with a high speed at a place where person exists within a time period C. In this example case, a waveform of voltage output from the energy converting device 201 has voltage levels exceeding given thresholds, and the polarity of waveform of voltage switches between positive and negative values with a shorter cycle as indicated as a time period B.

### (Determination Process)

When the voltage level changes suddenly as illustrated as the voltage waveform 604 and the voltage waveform 606 in FIG. 7, and the voltage level exceeding given thresholds (e.g., second positive threshold 2, second negative threshold 2) is output from the energy converting device 201 of the detection apparatus 20, the determination unit 12 of the information processing apparatus 10 determines that a person is performing a dangerous action such as jumping.

Further, when a time period that the polarity of the voltage waveform changes (e.g., time period B in FIG. 8) is equal to or less than a given time “t,” the determination unit 12 determines that a person is performing a dangerous actions such as stepping or kicking.

Further, when the polarity of voltage is switched between the positive and negative values while the voltage level is exceeding a given amplitude range defined by given thresholds (e.g., first positive threshold and first negative threshold) for a given number of times or snore during the time period C (see FIG. 8), the determination unit 12 determines that a person is performing a dangerous action such as stepping or kicking.

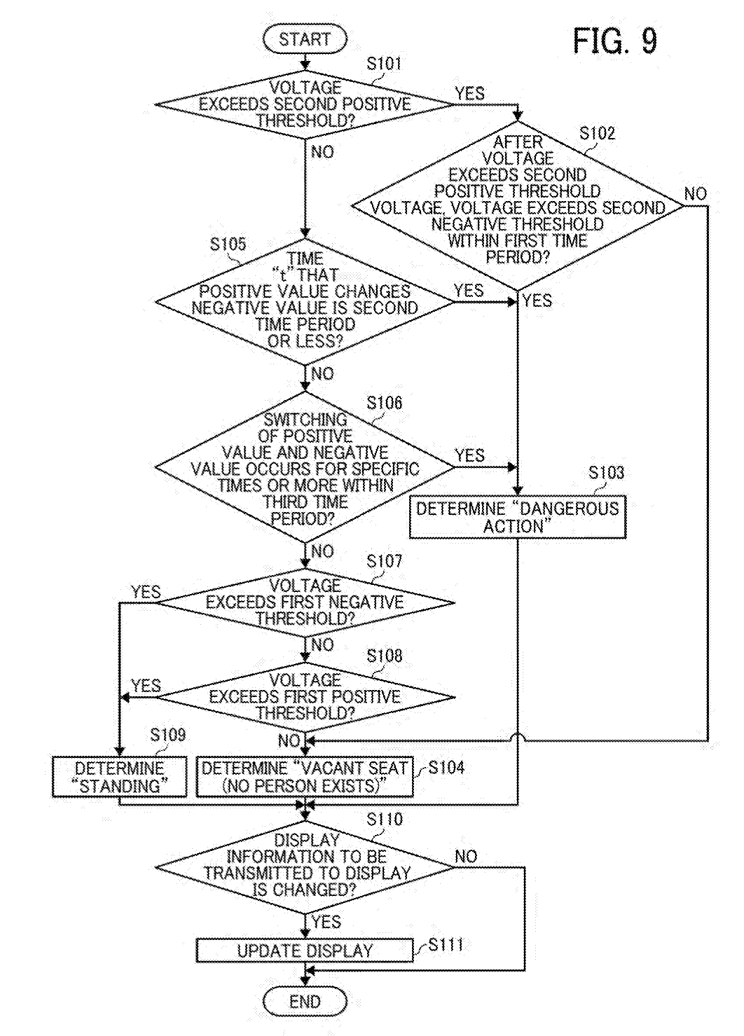

A description is given of a determination process by the determination unit 12 with reference to FIG. 9. FIG. 9 is an example of a flow chart illustrating the steps of a determination process by the determination unit 12.

At first, when the determination unit 12 receives a waveform data of voltage from the detection apparatus 20, the determination unit 12 determines whether the received waveform data of voltage exceeds a second positive threshold (step S101). In this description, the waveform data of voltage may be also referred to as the voltage pattern.

When the received waveform data of voltage exceeds the second positive threshold (step S101: YES), the determination unit 12 determines whether the receded waveform data of voltage exceeds a second negative threshold within a first time period (step S102), in which the exceeding the second negative threshold means that a voltage level becomes a negative value having an absolute value greater than an absolute value of the second negative threshold.

When the received waveform data of voltage exceeds the second negative threshold within the first time period (step S102: YES), the determination unit 12 determines that a behavior of person (i.e., target of monitoring) is “dangerous action” (step S103), and the sequence proceeds to step S110.

When the received waveform data of voltage does not exceed the second negative threshold within the first time period (step S102: NO), the determination unit 12 determines that behavior of person is “vacant seat (i.e., no person exists)” (step S104), and the sequence proceeds to step S110.

When the received waveform data of voltage does not exceed the second positive threshold (step S101: NO), the determination unit 12 determines whether a time “t” that the positive polarity of voltage changes to the negative polarity of voltage is less than or equal to a second time period (step S105).

When the time “t” that the positive polarity of voltage changes to the negative polarity of voltage is less than or equal to the second time period (step S105: YES), the sequence proceeds to step S103.

When the time “t” that the positive polarity of voltage changes to the negative polarity of voltage is longer than the second time period (step S105: NO), the determination unit 12 determines whether the switching between the positive polarity and the negative polarity of the voltage is detected for a given number of times or more within a third time period (step S106).

When the switching between the positive polarity and the negative polarity of the voltage is detected for the given number of times or more within the third time period (step S106: YES), the sequence proceeds to step S103.

When the switching between the positive polarity and the negative polarity of the voltage is detected with less than the given number of times within the third time period (step S106: NO), the determination unit 12 determines whether the received waveform data of voltage exceeds a first negative threshold (step S107), in which the exceeding the first negative threshold means that a voltage level becomes a negative value having an absolute value greater than an absolute value of the first negative threshold.

When the received waveform data of voltage exceeds the first negative threshold (step S107: YES), the sequence proceeds to step S109.

When the received waveform data of voltage does not exceed the first negative threshold ( step S107: NO), the determination unit 12 determines whether the received waveform data of voltage exceeds a first positive threshold (step S108).

When the received waveform data of voltage does not exceed the first positive threshold (step S108: NO), the sequence proceeds to step S104.

When the received waveform data of voltage exceeds the first positive threshold (step S108: YES), the determination unit 12 determines that the behavior of person (i.e., target of monitoring) is “standing” (step S109).

Then, the determination unit 12 determines whether the behavior of person (i.e., target of monitoring) determined by performing the above described steps changes from the behavior of person currently displayed on the display (step S110).

When the behavior of person determined by performing the above described steps does not change from the behavior of person currently displayed on the display (step S110: NO), the sequence is ended.

When the behavior of person determined by performing the above described steps changes from the behavior of person currently displayed on the display (step S110: YES), the determination unit 12 updates display information of the behavior of person (i.e., target of monitoring) (step S111), and then the sequence is ended.

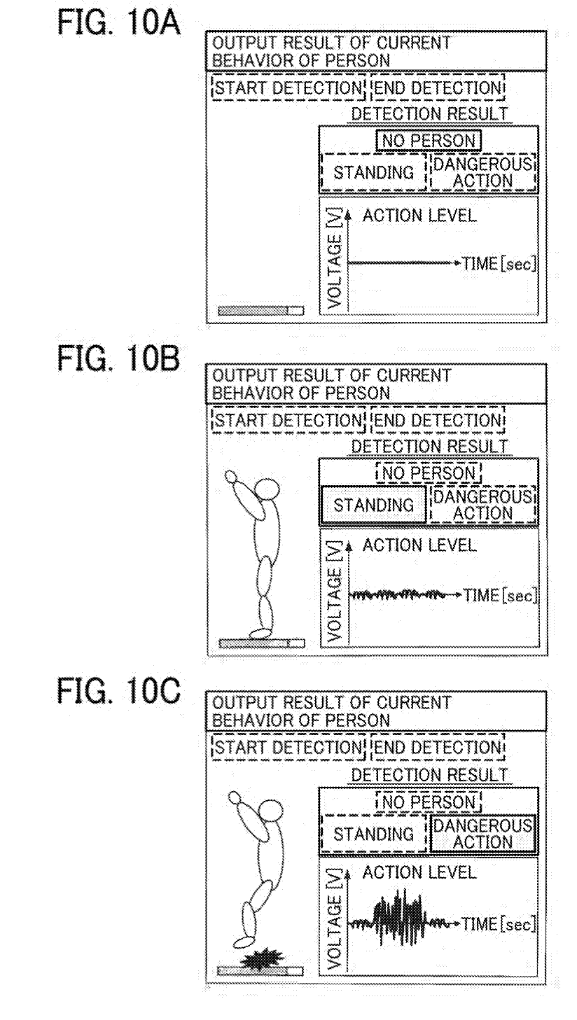

FIG. 10 illustrates examples of screen images corresponding to behaviors of person (i.e., target of monitoring) displayed on the display. FIG. 10A illustrates an example of a screen image when the behavior of person is “dangerous action.” FIG. 10B illustrates an example of a screen image when the behavior of person is “vacant seat (no person exists).” FIG. 10C illustrates an example of a screen image when the behavior of person is “standing.” for example, the behavior of person can be displayed as figures/drawings, and displayed color and/or text size can be changed. Further, the waveform data of voltage can be displayed as illustrated in FIG. 10. Further, the behavior of person can be output by using sound and/or light.

### Second Embodiment

The first embodiment describes that the behavior of person is determined based on the waveform of voltage acquired for the monitored person.

In the second embodiment, the behavior of person is determined based on the waveform of voltage acquired for the monitored person (i.e., first embodiment) and a score calculated front the waveform of voltage acquired for the monitored person.

Further, since most of the second embodiment is the same as the first embodiment except for a part of the second embodiment, the redundant description is omitted as appropriate.

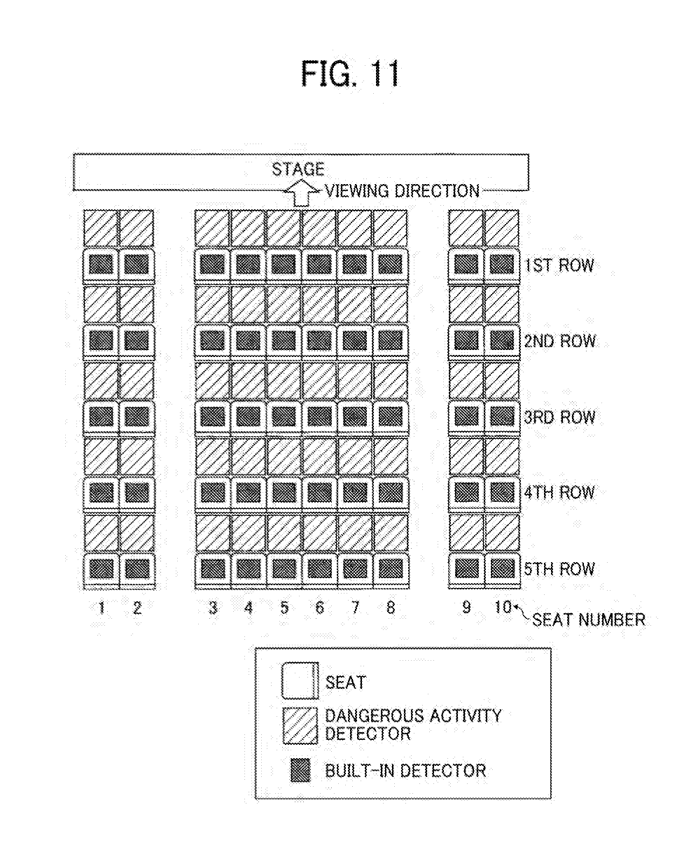

FIG. 11 illustrates an example of an arrangement of a detection apparatus 20a of the second embodiment disposed at each seat. The detection apparatus 20a used as the second embodiment includes, for example, a plurality of energy converting devices such as a first energy converting device 201a and a second energy converting device 201b. For example, the first energy converting device 201a is disposed at a loot of each seat, and the second energy converting device 201b is disposed at a portion of each seat to be seated by a person. In this configuration, the first energy converting device 201a can be referred to as a “dangerous activity detector” while the second energy converting device 201b can be referred to as a “built-in detector” because the second energy converting device 201b is built-in each seat. Further, the second energy converting device 201b can be built in a chair or a cushion on a chair.

In this description, to be described later, the first energy converting device 201a (dangerous activity detector) is used to detect a dangerous action of a person as a first type effect caused by an action of the person, and the second energy converting device 201b (built-in detector) is used to detect electromagnetic (EM) noise, received through a human body functioning as an antenna, as a second type effect caused by an action of the person.

### (Hardware Configuration)

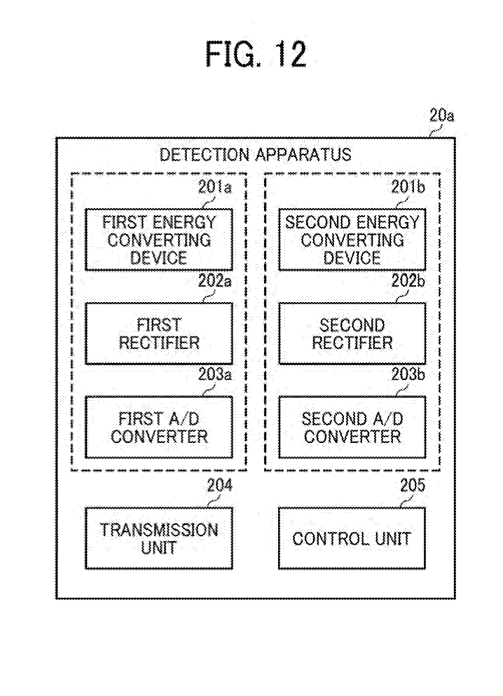

FIG. 12 illustrates an example of a hardware block diagram of the detection apparatus 20a of the second embodiment. The detection apparatus 20a of the second embodiment includes, for example, a plurality of energy converting devices such as the first energy converting device 201a and the second energy converting device 201b, a plurality of rectifiers such as a first rectifier 202a and a second rectifier 202b, respectively corresponding to the first energy converting device 201a and the second energy converting device 201b, a plurality of analog/digital (A/D) converters such as a first A/D converter 203a and a second A/D converter 203b respectively corresponding to the first energy converting device 201a and that second energy converting device 201b and the first rectifier 202a and the second rectifier 202b, a transmission unit 204, and a control unit 205.

Further, the first energy converting device 201a is disposed at the foot of each seat, and the second energy converting device 201b is disposed at a portion of each seat to be seated by a person where buttocks of the person is placed on.

When the control unit 205 detects electromagnetic (EM) noise, received through a human body functioning as the antenna, output from the second energy converting device 201b (i.e., second piezoelectric element), and then detects that a voltage having a voltage level equal to or greater than a given threshold is output from the second energy converting device 201b, the control unit 205 transmits a waveform of voltage output from the first energy converting device 201a (i.e., first piezoelectric element) to the information processing apparatus 10. The waveform of voltage is also referred to as the voltage pattern.

Further, when the control unit 205 receives a waveform of voltage (voltage pattern) output from the first piezoelectric element alone, the control unit 205 can transmit the waveform of voltage output from the first energy converting device 201a to the information processing apparatus 10. Specifically, when the control unit 205 detects that a voltage having a voltage level equal to or greater than the given threshold is output from the first energy converting device 201a, the control unit 205 transmits a waveform of voltage output from the first energy converting device 201a to the information processing apparatus 10.

With this configuration, data amount transmitted to the information processing apparatus 10 can be reduced, with which the processing load at the information processing apparatus 10 can be reduced.

### (Waveform Data of Voltage)

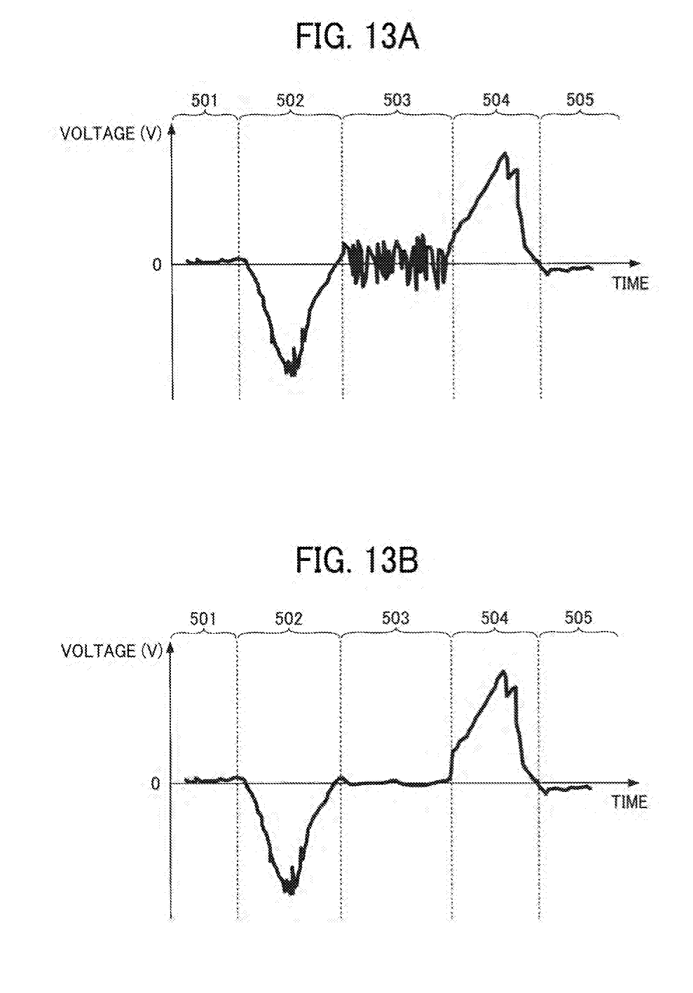

A description is given of waveform data of voltage output from the second energy converting device 201b disposed at a portion of each seat to be seated by a person with reference to FIG. 13. The first energy converting device 201a and the second energy converting device 201b can be configured by using the same configuration of the energy converting device 201 of the first embodiment.

FIG. 13A illustrates an example of a waveform of voltage output from the second energy converting device 201b when a person sits on a seat, is sitting on the seat and, leaves from the seat in time periods 501 to 505.

In this example case, the person is not seated on the seat in the time period 501 and the time period 505 in FIG. 13A. Therefore, the energy converting device 201 outputs little signal in the time period 501 and the time period 505.

When the person is just seated on the seat in the time period 502 of FIG. 13A, the energy converting device 201 outputs a relatively greater negative voltage in the time period 502.

When the person is being seated on the seat in the time period 503 of FIG. 13A, the energy converting device 201 outputs voltage including electromagnetic (EM) noise, caused by electromagnetic waves received through the human body (i.e., antenna) seating on or over the energy converting device 201 in the time period 503. For example, when a value of 1024 and a value of −1024 are respectively set for a voltage of 5V and a voltage of −5V in the time period 503. She energy converting device 201 outputs electrical signals exceeding a range of 30 to −30 and fluctuating with a shorter interval.

When the person stands up from the seat in the time period 504 of FIG. 13A, the energy converting device 201 outputs a relatively greater positive voltage in the time period 504.

FIG. 13B illustrates an example of a waveform of voltage output from the second energy converting device 201b when an object is placed on a seal. The waveform of voltage of FIG. 13B and the waveform of voltage of FIG. 13A are different greatly in the time period 503 because the waveform of voltage including electromagnetic (EM) noise (electromagnetic wave noise) is output when the person is on or over the electricity generation rubber by receiving the electromagnetic waves through the human body (FIG. 13A) and the waveform of voltage becomes almost constant voltage when the object, not receiving the electromagnetic waves, is on or over the electricity generation rubber.

### (Processing)

A description is given of processing of the behavior management system 1 of the second embodiment, which is different from the first embodiment.

### (Processing of Detection Apparatus)

Typically, a dangerous behavior or action occurs when a person is standing from a seat. Therefore, for example, when a person is seated on a seat (when the seat condition is “seated”), the detection apparatus 20a can be configured not to transmit waveform data of voltage to the information processing apparatus 10.

In this example case, the detection apparatus 20a of the second embodiment is used to monitor and manage the seat condition. For example, the detection apparatus 20a can be configured to transmit waveform data of voltage to the information processing apparatus 10 only when the seat condition is changed, and a person is standing. With this configuration, data amount transmitted to the information processing apparatus 10 can be reduced.

Further, the transmission unit 204 of the detection apparatus 20a of the second embodiment can be configured not to transmit the waveform data of voltage to the information processing apparatus 10 when the fluctuation level and absolute value of voltage output from the first energy converting device 201a, disposed at the foot of each seat, is within a given range even if the seat condition is determined as “standing.” With this configuration, when it is determined that a person is standing without performing a dangerous action, data amount transmitted to the information processing apparatus 10 can be reduced.

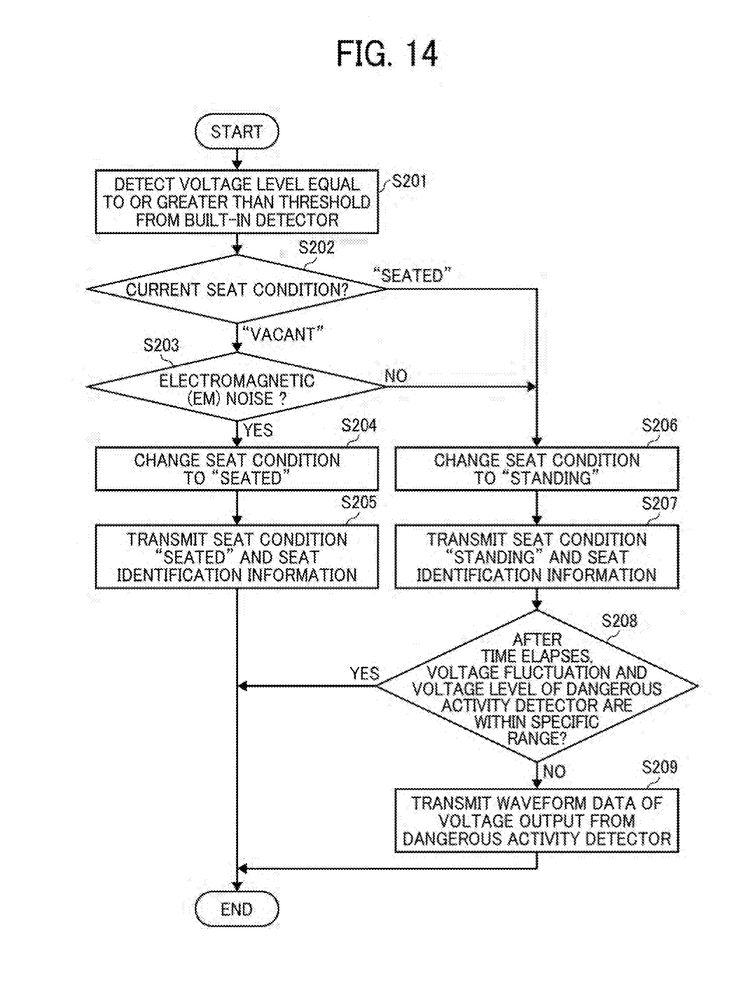

A description is given of processing of the detection apparatus 20a of the second embodiment with reference to FIG. 14. FIG. 14 is an example of a flow chart illustrating the steps of processing of the detection apparatus 20a of the second embodiment.

The control unit 205 of the detection apparatus 20a of the second embodiment can be configured to start the processing, for example, when the detection apparatus 20a receives a detection start instruction from the information processing apparatus 10. Further, when the control unit 205 starts the processing, the control unit 205 can initialize the stored data. For example, the control unit 205 resets the seat condition to “vacant seat.”

At first, the control unit 205 detects that a voltage having a voltage level equal to or greater than a given threshold is output from the second energy convening device 201b used as the built-in detector, in which the polarity of voltage is any one of positive and negative (step S201).

Then, the control unit 205 determines the current seat condition (step S202).

When the current seat condition is “vacant seat” (step S202: “vacant”), the control unit 205 determines whether the waveform of voltage output from the second energy convening device 201b after a given time period elapses is caused by electromagnetic (EM) noise as indicated in the time period 503 of FIG. 13A (step S203). In this case, for example, a value of 1024 and a value of −1024 are respectively set for a voltage of 5V and a voltage of −5V, and a range of 30 to −30 is set to determine whether the waveform of voltage output from the second energy converting device 201b is caused by electromagnetic (EM) noise. Specifically, when the amplitude of the voltage fluctuates between the positive and negative polarity for a given number of times or more by exceeding the range of 30 to −30 while a switching interval time between the positive and the negative polarities is within a given time value during a given time period (e.g., 5 second), the control unit 205 can be configured to determine that the waveform of voltage output from the second energy converting device 201b is caused by electromagnetic (EM) noise.

When the waveform of voltage output from the second energy converting device 201b is not caused by the electromagnetic (EM) noise (step S203: NO), the sequence proceeds to step S206.

When the waveform of voltage output from the second energy converting device 201b is caused by the electromagnetic (EM) noise (step S203: YES), the control unit 205 changes the seat condition to “seated” (step S204).

Then, the control unit 205 instructs the transmission unit 204 to transmit the seat condition “seated” and seat identification information (e.g., position information) to the information processing apparatus 10 (step S205), and then the sequence is ended.

When the current seat condition is “seated” (step S202: “seated”), the control unit 205 changes the seat condition to “standing” (step S206).

Then, the control unit 205 instructs the transmission unit 204 to transmit the seat condition “standing” and seat identification information (e.g., position information) to the information processing apparatus 10 (step S207).

Then, the control unit 205 determines whether the fluctuation level and absolute value of the voltage output from the first energy converting device 201a, used as the dangerous activity detector, is within a given range after a given time period elapses (step S208).

When the fluctuation level and absolute value of voltage output from the first energy converting device 201a is within the given range (step S208: YES), the sequence is ended.

When the fluctuation level and absolute value of voltage output from the first energy converting device 201a is not within the given range (step S208: NO), which means when the fluctuation level and absolute value of voltage output from the first energy converting device 201a exceeds the given range, the control unit 205 instructs the transmission unit 204 to transmit the waveform data of voltage output from the first energy converting device 201a (i.e., dangerous activity detector) to the information processing apparatus 10 (step S209).

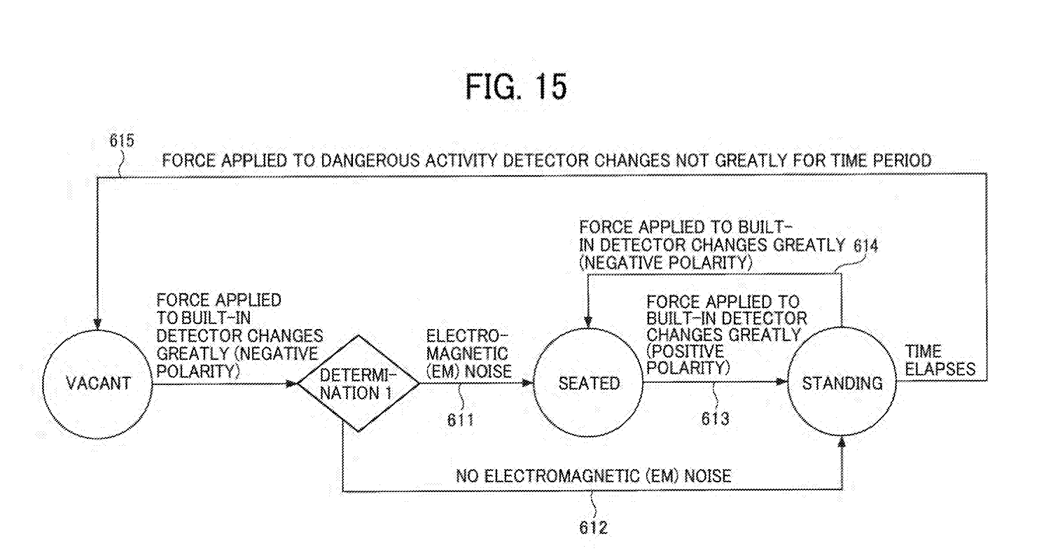

FIG. 15 illustrates an example of transitions of the seat condition detectable by using the defection apparatus 20a of the second embodiment.

When the seat condition is “vacant seat,” and a greater downward force change is applied to the second energy converting device 201b used as the built-in detector, and a waveform of voltage output from the second energy converting device 201b becomes the waveform of voltage in the time period 503 of FIG. 13(A) caused by the electromagnetic (EM) noise, the seat condition becomes “seated” (i.e., transition 611 in FIG. 15).

When the seat condition is “vacant seat,” and a greater upward force change is applied to the second energy converting device 201b used as the built-in detector, and a waveform of voltage output from the second energy converting device 201b does not become the waveform of voltage in the time period 503 of FIG. 13(A) caused by the electromagnetic (EM) noise, the seat condition becomes “standing” (i.e., transition 612 in FIG. 15) because this condition can be estimated that an object (e.g., bag) is placed on a chair while a person is not seated on the chair.

When the seat condition is “seated,” and a greater force change is applied to the second energy converting device 201b used as the built-in detector, the seat condition becomes “standing” (i.e., transition 613 in FIG. 15) because this condition can be estimated that a person stands up.

When the seat condition is “standing,” and a greater downward force change is applied to the second energy converting device 201b used as the built-in detector, and a waveform of voltage output from the second energy converting device 201b becomes the waveform of voltage in the time period 503 of FIG. 13(A) caused by the electromagnetic (EM) noise, the seat condition becomes “seated” (i.e., transition 614 in FIG. 15).

When the seat condition is “standing,” and a force change applied to the first energy convening device 201a used as the dangerous activity detector does not occur for a given time period or more continuously, the seat condition becomes “vacant seat” (i.e., transition 615 in FIG. 15).

### (Processing of Information Processing Apparatus)

When the information processing apparatus 10 is activated, for example, the information processing apparatus 10 performs an initialization process such as resetting various parameters, inputting a layout of a hall, resetting a display, and setting a transmission destination of analysis data. Further, the detection apparatus 20a can be configured to automatically transmit a process start request to the information processing apparatus 10.

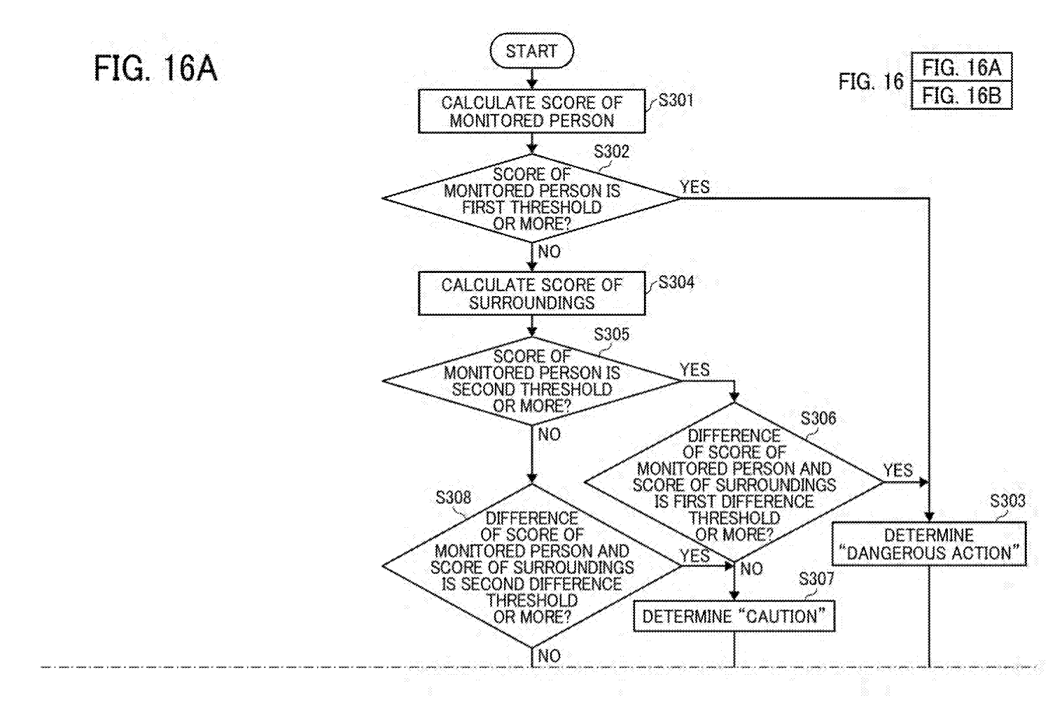

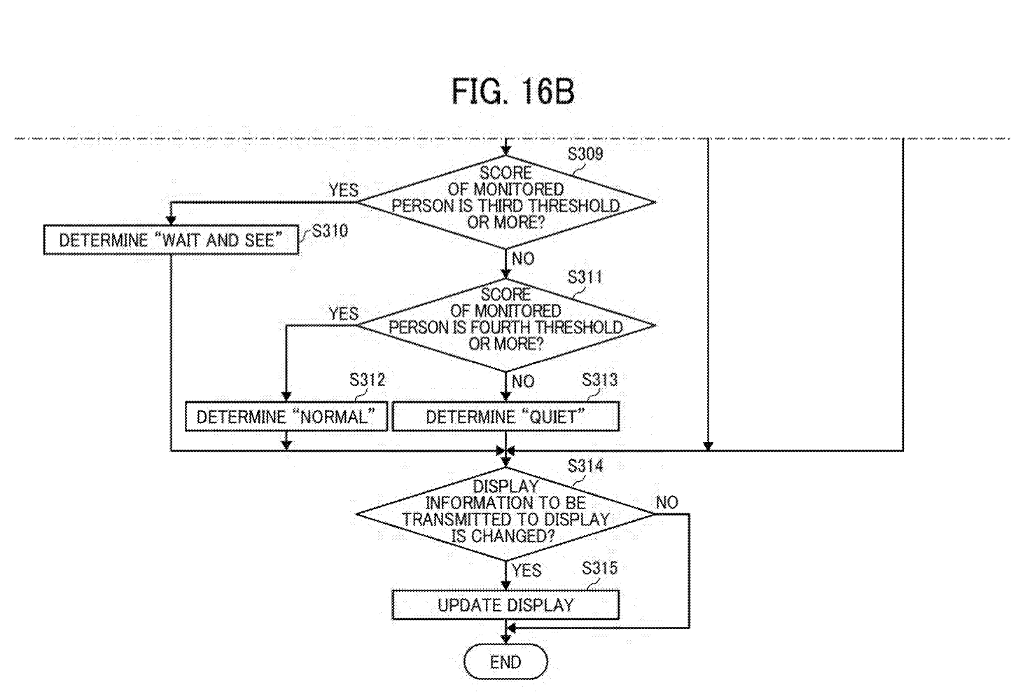

A description is given of a determination process by the determination unit 12 of the information processing apparatus 10 of the second embodiment with reference to FIG. 16.

As to the second embodiment, the determination unit 12 performs the determination process of the first embodiment (FIG. 9) and further performs a determination process of FIG. 16. FIG. 16 is an example of a flow chart illustrating the steps of a determination process of the second embodiment.

The determination unit 12 calculates a score indicating a danger level of the behavior of person that is monitored (step S301).

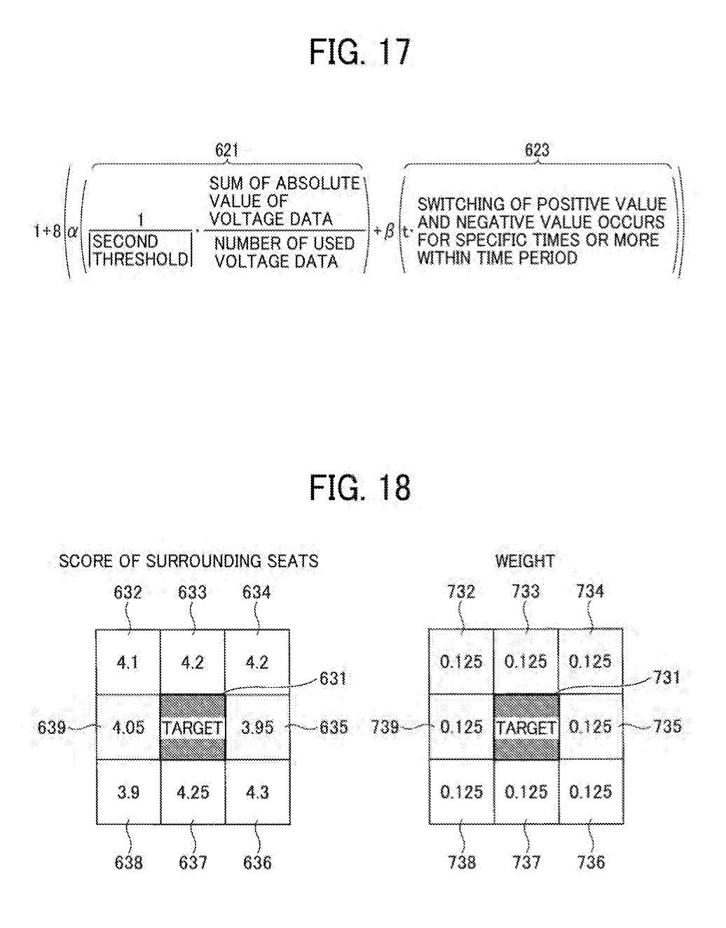

FIG. 17 illustrates a method of calculating a score of the monitored person. For example, the determination unit 12 calculates the score of the monitored person based on waveform data of voltage output from the dangerous activity detector by using the equation of FIG. 17, in which fixed values “1” and “8” are just, examples, and the fixed valises can be changed depending on a range of the score.

In the equation of FIG. 17, a term 621 multiplied to a coefficient “α” is an equation to calculate an average value of absolute values of the voltage, in which a value of the term 621 is constantly one or less.

In the equation of FIG. 17, the term 621 multiplied to a coefficient “β” is an equation to calculate the number of times of the polarity switching of voltage with respect to a limit value “t,” in which a value of the term 623 is constantly one or less.

The coefficients “α” and “β” are parameters that can be adjusted depending on a dangerous action to be detected. For example, when jumping of person, which changes voltage greatly, is to be effectively detected, the coefficient α is set greater, and when foot kicking of a person at one place, which switches the polarity between positive and negative very frequently, is to be effectively detected, the coefficient β is set greater.

Then, the determination unit 12 determines whether the score of the monitored person is a first threshold (e.g., 8) or more (step S302).

When the calculated score is the first threshold or more (step S302: YES), the determination unit 12 determines that behavior of the monitored person is a “dangerous action” (step S303), and the sequence proceeds to step S314. Further, in this case, the information processing apparatus 10 can be configured to report to a given terminal device that the monitored person is performing the dangerous action.

When the calculated score is less than the first threshold (step S302: NO), the determination unit 12 calculates a score of surroundings of the monitored person (step S304).

### (Method of Calculation of Score of Surroundings)

FIG. 18 illustrates a method of calculating a score of the surroundings of the monitored person. As illustrated in FIG. 18, the score is calculated for each of persons at each of seats 632 to 639 surrounding the monitored person 631, and the score is multiplied with a respective specific weight, wherein the sum of weights is 1, and then the weight-multiplied scores of the seats 632 to 639 are totaled to calculate a total score of the surroundings of the monitored person 631. In an example case of FIG. 18, the total score of the surroundings of the monitored person 631 is calculated as 4.12.

Then the determination unit 12 determines whether the score of the monitored person is a second threshold (e.g., 6.5) or more, in which the second threshold is set smaller than the first threshold (step S305).

When the score of the monitored person is the second threshold or more (step S305: YES), the determination unit 12 determines whether the difference of the score of the monitored person and the total score of the surroundings is a first difference threshold (e.g., 2) or more (step S306).

When the difference of the score of the monitored person and the score of the surroundings is the first difference threshold or more (step S306: YES), the determination unit 12 determines that the monitored person performs an abnormal behavior compared to the surroundings, and then the sequence proceeds to step S303.

When the difference of the score of the monitored person and the score of the surroundings is less than the first difference threshold (step S306: NO), the determination unit 12 determines that the behavior of the monitored person as “caution” (step S307), and then the sequence proceeds to step S314.

When the score of the monitored person is less than the second threshold (step S305: NO), the determination unit 12 determines whether the difference of the score of the monitored person and the total score of the surroundings is a second difference threshold (e.g., 2.5) or more (step S308).

When the difference of the score of the monitored person and the total score of the surroundings is the second difference threshold or more (step S308; YES), the sequence proceeds to step S307.

When the difference of the score of the monitored person and the total score of the surroundings is less than the second threshold (step S308: NO), the determination unit 12 determines whether the score of the monitored person is a third threshold (e.g., 5) or more, in which the third threshold is set smaller than the second threshold (step S309).

When the score of the monitored person is the third threshold or more (step S309: YES), the determination unit 12 determines that the behavior of the monitored person as “wait and see” (step S310), and then the sequence proceeds to step S314.

When the score of the monitored person is less than the third threshold (step S309: NO), the determination unit 12 determines whether the score of the monitored person is a fourth threshold (e.g., 3) or more, in which the fourth threshold is set smaller than the third threshold (step S311).

When the score of the monitored person is the fourth threshold or more (step S311: YES), the determination unit 12 determines that the behavior of the monitored person as “normal” (step S312), and then the sequence proceeds to step S314.

When the score of the monitored person is less than the fourth threshold (step S311: NO), the determination unit 12 determines that the behavior of the monitored person as “quiet” (step S313).

Then, the determination unit 12 determines whether the behavior of person (i.e., target of monitoring) determined by performing the above described steps is changed from the behavior of person currently displayed on the display (step S314).

When the behavior of person (i.e., target of monitoring) determined by performing the above described steps is not changed from the behavior of person currently displayed on the display (step S314: NO), and then the sequence is ended.

When the behavior of person (i.e., target of monitoring) determined by performing the above described steps is changed from the behavior of person currently displayed on the display (step S314; YES), the determination unit 12 updates display information of the behavior of person (i.e., target of monitoring) (step S315), and then the sequence is ended.

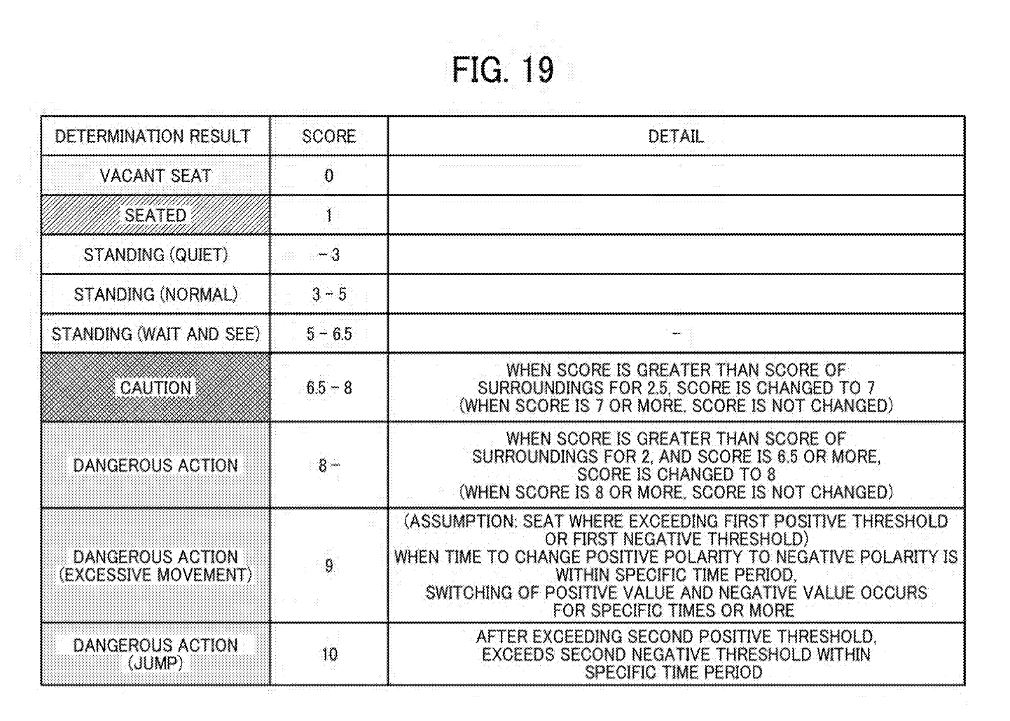

A description is given of an example of a table correlating behaviors of the monitored person and scores when the determination process of FIGS. 9 and 16 of the second embodiment is performed with reference to FIG. 19. FIG. 19 illustrates an example of a table correlating determination results of behavior of the monitored person and scores.

As illustrated in FIG. 19, the behavior of the monitored person can be determined based on the scores such as “vacant seat,” “seated,” “standing (quiet).” “standing (normal).” “standing (wait and see).” “caution,” “dangerous action,” “dangerous action (excessive movement at place).” and “dangerous action (jump).”

Further, it is assumed that the scores of “vacant seat,” “seated.” “dangerous action (excessive movement),” and “dangerous action (jump)” are pre-set instead of using the equation of FIG. 17.

For example, in the sequence of FIG. 9, it is determined as “vacant seat” at step S104, “dangerous action (excessive movement at place)” at step S102 (YES), and “dangerous action (jump)” at step S106 (YES), and the score of “vacant seat,” “dangerous action (excessive movement),” and “dangerous action (jump)” is respectively determined as “0,” “9,” and “10” as illustrated in FIG. 19

As to “seated,” the score is determined as “1” when the “seated” is reported from the detection apparatus 20a by performing the sequence of FIG. 14. Further, “seated” can be determined by the information processing apparatus 10, in which the detection apparatus 20a transmits waveform data of voltage output from the built-in detector to the information processing apparatus 10, and then the determination unit 12 of the information processing apparatus 10 determines that the seat condition is “seated” by performing the sequence of FIG. 14.

As illustrated the detail in FIG. 19, the determination results of behavior of the monitored person can be corrected based on the score of the surroundings. For example, as described with reference to FIG. 16, when the difference of the score of target of monitoring and the total score of the surroundings is the second difference threshold or more, the score is automatically or mandatory set to “7,” and the “caution” is displayed. Further, when the difference of the score of target of monitoring and the total score of the surroundings is the first difference threshold or more, and the score of target of monitoring is the second threshold or more, the score is automatically or mandatory set to “8,” and “dangerous action” is displayed.

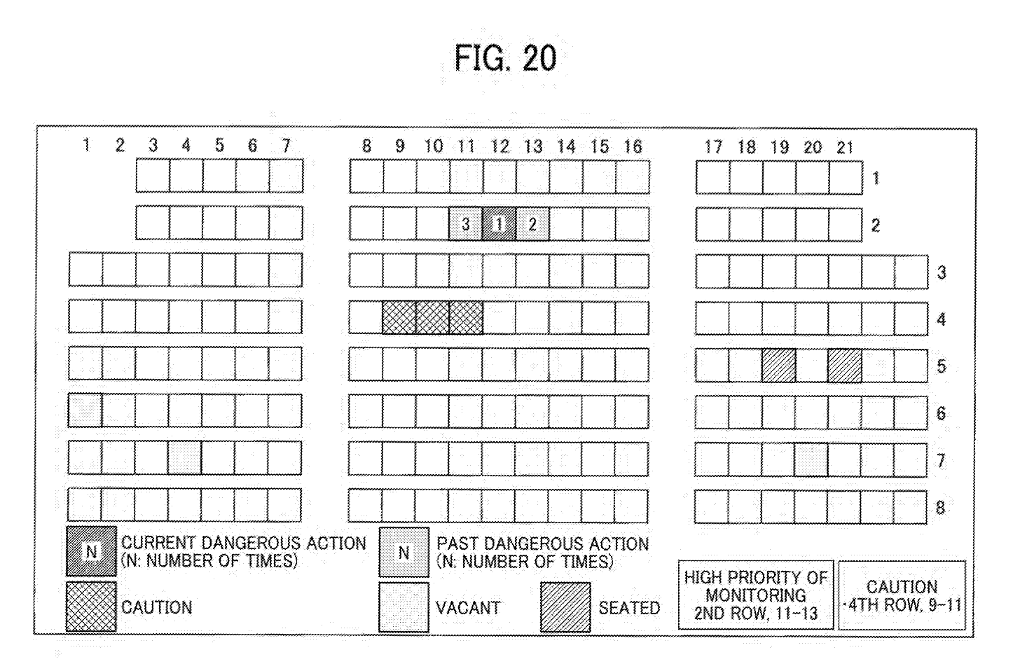

FIG. 20 illustrates an example of display information of behavior of the monitored person. The display information includes information of condition of person (e.g., audience) at each seat. For example, the display information includes color information and text information indicating the behavior of the monitored person, in which a person performing a dangerous action now, a person that performed a dangerous action bid not performing now, a person seated on a seat, a person performing an caution action that is not a dangerous action, a vacant seat, and a person standing normally are indicated by changing color information and highlighting text information, and further, critically important portion or area alone can be enlarged and displayed.

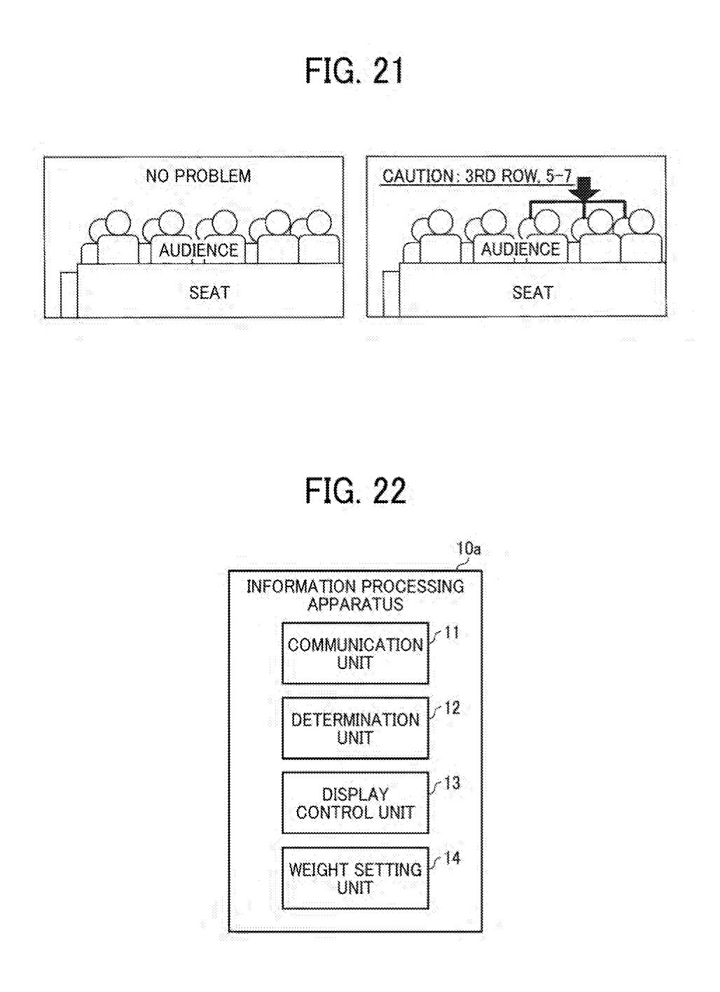

FIG. 21 illustrates an example of display information of the behavior of the monitored person displayed on a resmote terminal device. The determination unit 12 selects critical information (e.g., caution required person) from the determination of the behavior of the monitored person, and displays the critical information on the remote terminal device such as a wearable terminal carried by monitoring staff in a hall.

### Third Embodiment

As to the third embodiment, the score of the surroundings is calculated as follows, which is different from the score of the surroundings calculated in the second embodiment. As to the third embodiment, the behavior of the monitored person is determined based on a relative positional relationship of a seat of the monitored person and each of seats surrounding the seat of the monitored person, a position of the seat of the monitored person in a hall, and dispersion of scores of persons at each of seats surrounding the seat of the monitored person.

Further, since most of the third embodiment is the same as the first embodiment or second embodiment except for a part of the third embodiment, the redundant description is omitted as appropriate.

### (Functional Block Diagram of Information Processing Apparatus)

A description is given of an example of a functional block diagram of the information processing apparatus 10a of the third embodiment with reference to FIG. 22.

As illustrated in FIG. 22, the information processing apparatus 10a of the third embodiment further includes, for example, a weight setting unit 14.

The weight setting unit 14 sets a weight to each of seats surrounding the seat of the monitored person based on a relative positional relationship of a seat of the monitored person and each of seats surrounding the seat of the monitored person, a position of the seat of the monitored person in a hall, and dispersion of scores of persons at each of seats surrounding the seat of the monitored person.

### (Calculation of Score of Surroundings)

When the monitored person is present with a plurality of other persons such as friends and family in the same row in a hall, arranged for example in one direction, the monitored person and other persons next to or near the monitored person may perform the same or similar action in some cases. If the weight is set uniformly for the monitored person and the other persons next to or near the monitored person by applying the calculation method of the second embodiment (FIG. 18), a dangerous action may not be determined correctly in some cases.

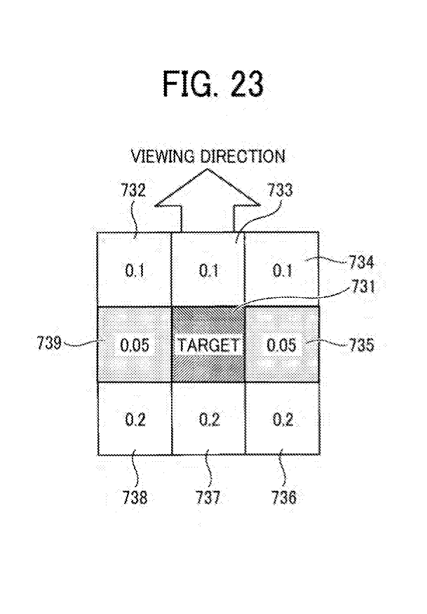

Therefore, as to the third embodiment, the weight setting unit 14 sets a weight for a person in the same row of the monitored person with a relatively smaller value. FIG. 23 illustrates an example of setting a relatively smaller weight for each of persons in the same row of the monitored person. As illustrated in FIG. 23, when the monitored person, a person 735 next to the monitored person, and a person 739 next to the monitored person are present in the same row with respect to a viewing direction of a stage, the weight setting unit 14 sets a weight of the person 735 and a weight of the person 739 present next to the monitored person in the same row with relatively smaller values.

Further, since the visibility of the stage from each person, which may be affected by an viewing angle from each seat and an obstruction in front of eyes such as person in front of eyes, and the viewing direction of each person become different depending on seat positions in a hall, the affection level of behavior affecting surrounding persons become different depending the seat positions. For example, the affection level of the excessive movement or action of person at the front row facing the stage to the surrounding persons, and the affection level of the excessive movement of person at the last row to the surrounding persons become different greatly. Further, the enthusiasm level become different depending on the seal positions in an event hall and an event contents.

Therefore, the weight setting unit 14 sets a weight for each seat in a hall depending on positions of seats in the hall. For example, the weight setting unit 14 sets a higher weight for one or more seats where the affection level becomes greater, and a lower weight for one or more seats where the affection level becomes smaller.

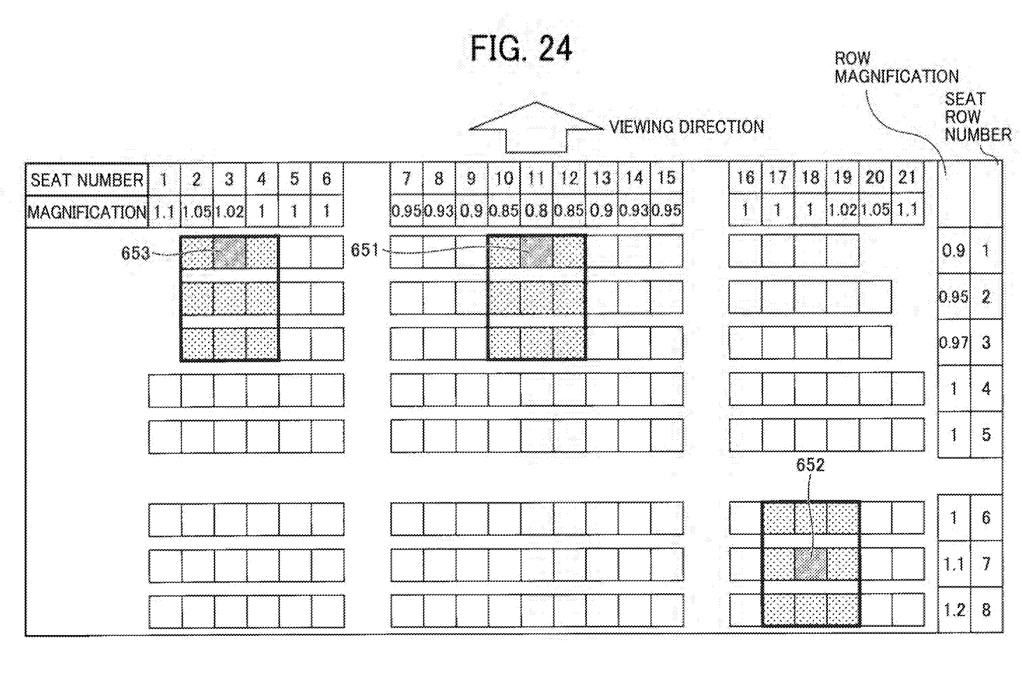

A description is given of an example of setting of weight for each seat in a hall depending on positions of seats in the hall with reference to FIG. 24. In this disclosure, the hall is an example of a three dimensional space, which means the three dimensional space is not limited to the hall.

In an example case of FIG. 24, a seat 651 at the first row and the seat number 11 has the magnification of 0.8 set for the seat number 11 and the magnification of 0.9 for the row number 1, and thereby the weight setting unit 14 multiples the two magnifications to calculate 0.72 as a weight of the scat 651. Similarly, the weight setting unit 14 calculates weight of 1.1 for a seat 652 at the seventh row and the seat number 15, and a weight of 0.92 for a seat 653 at the first row and the seat number 3.

Since the sear 651, which is at the center in the front row, affects the surrounding persons greatly, a dangerous action is determined relatively strictly for the seat 651, and since the seat 652, which is a rear end seat, affects the surrounding persons smaller, a dangerous action is determined relatively less strictly for the seat 562.

As to the determination unit 12 of the third embodiment, when the scores of each of persons present a plurality of surrounding seats are calculated, some scores such as a score determined as “dangerous action” and a score determined as “vacant seat” may be excluded from a calculation of the score of the surroundings.

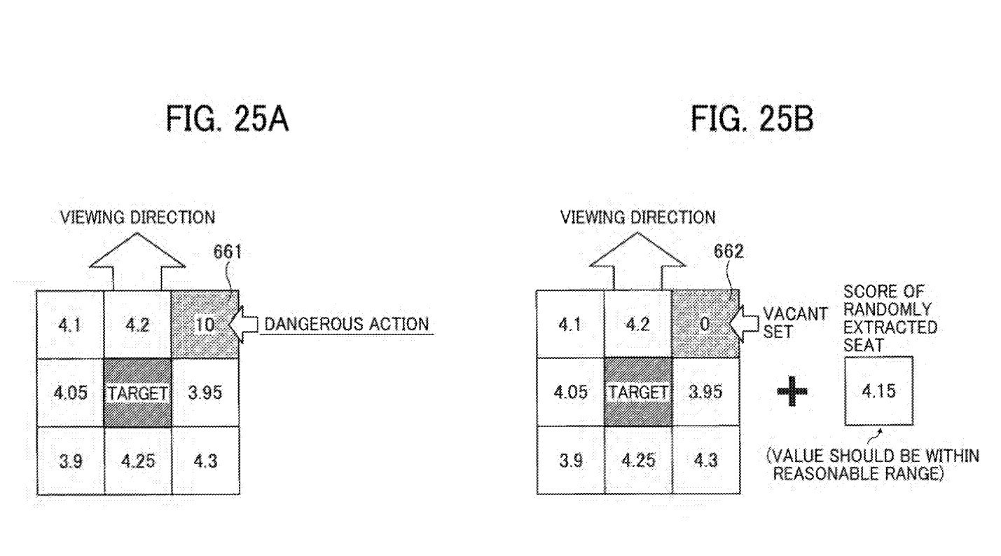

A description is given of a process of excluding a score of a specific point from a calculation of the score of the surroundings with reference to FIG. 25.

For example, a score at a seat 661 where a person performs a dangerous action (FIG. 25A) and a score at a seat 662 where a seat is a vacant seat (FIG. 25B) are excluded. In this case, the determination unit 12 can calculate the score of surroundings based on the remaining scores of surrounding seats. Further, the determination unit 12 can use a score of a seat near the seat excluded from the calculation, instead of the score of the seat excluded from the calculation, to calculate the score of surroundings.

### Fourth Embodiment

A description is given of a fourth embodiment, in which it is assumed that, two stages such as a main stage and a sub-stage, are set in a hall. When persons (e.g., audience) change a viewing direction from one viewing direction for viewing the main stage to another viewing direction tor viewing the sub-stage depending, on the event time line, weights used for calculating the score of the surroundings is dynamically changed.

Since most of the fourth embodiment is the same as the first embodiment to the third embodiment except for a part of the fourth embodiment, the redundant description is omitted as appropriate.

As to the fourth embodiment, the weight setting unit 14 acquires information indicating a viewing direction of audience, which may be changed, along the time line, and dynamically changes a weight value of each seat based on the acquired information.

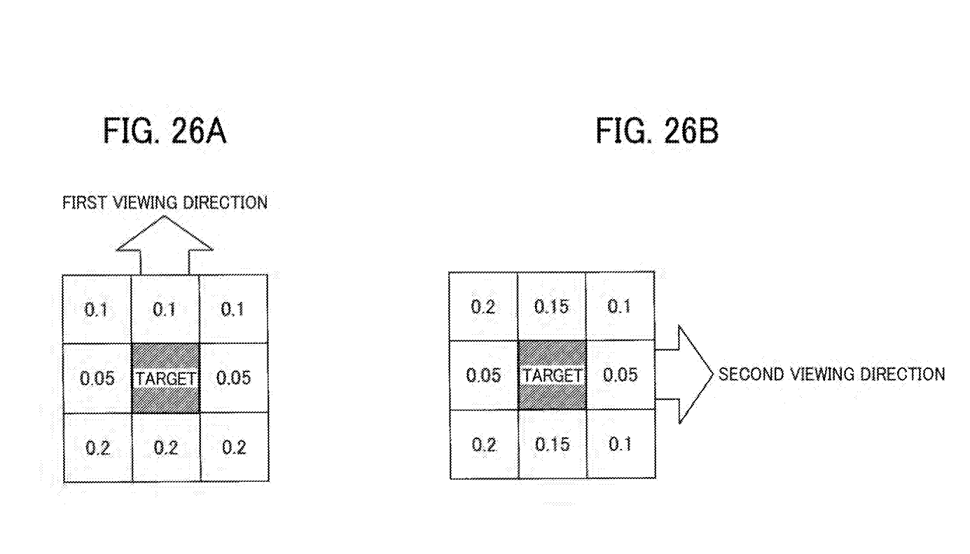

FIG. 26 illustrates an example of changing of weight values depending on a change of viewing direction of audience.

In an example case of FIG. 26A, the audience is viewing a first viewing direction, and in an example case of FIG. 26B, the audience is viewing a second viewing direction. When the viewing direction is changed from die first viewing direction (FIG. 26A) to the second viewing direction (FIG. 26B), the weight setting unit 14 set a greater weight for the audience at the left side of the hail compared to the audience at the right side of the hall as illustrated in FIG. 26B because when the viewing direction is changed to the second viewing direction (FIG. 26B), the audience at the left side of the hall (see FIG. 26A) becomes the audience at the rear side of a monitoring target person (see FIG. 26B) with respect to the second viewing, direction, and the behavior of the monitoring target person affects the audience at the left side of the hall greater than the audience at the right side of the hall in the example ease of FIG. 26B.

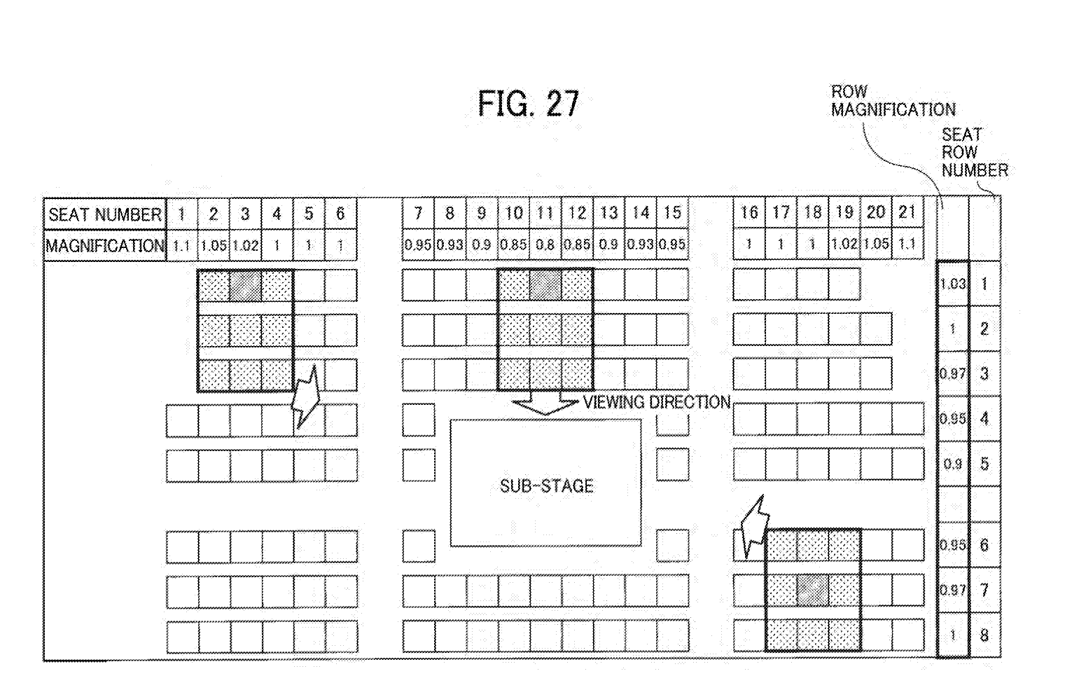

In an example case of FIG. 27, a sub-stage is set at the center of a hall, in which when the viewing direction is changed to the sub-stage, a weight value is changed.

In an example case of FIG. 27, the sub-stage is set at the center of a lateral direction of the hall. Therefore, the weight setting unit 14 uses the magnification of the seal number of FIG. 24 without changing. Further, when the sub-stage is set at, for example, a rightward position in the hall instead of the center of a lateral direction of the hall, the magnification is set smaller as seats are closer to the right end of the hall, and the magnification is set greater as seats are closer to the left end of the hall.

In an example case of FIG. 27, the weight setting unit 14 sets a smaller row magnification as seats are closer to the sub-stage.

Similar to the above third embodiment, the score of the surroundings can be calculated by multiplying the magnification set for each seat number and the magnification set for each row number, with which a weight used for calculating the score of the surroundings based on seat positions in the hall can be changed when the viewing direction is changed.

Further, the weight setting unit 14 can perform following processing. At first, the weight setting unit 14 acquires time line contents of an event to be performed on a stage prepared by an even producer. Then, the weight setting unit 14 analyzes the acquired information to extract concerned portion from information of sensors such as cameras and lighting devices to recognize real situations of the event with a real time manner based on the analyzed result, extraction result, and time line information. Then, the weight setting unit 14 sets a weight for the concerned portion when the concerned portion is changed.

### (Energy Converting Device)

A description is given of one or more configurations of the energy converting device 201.

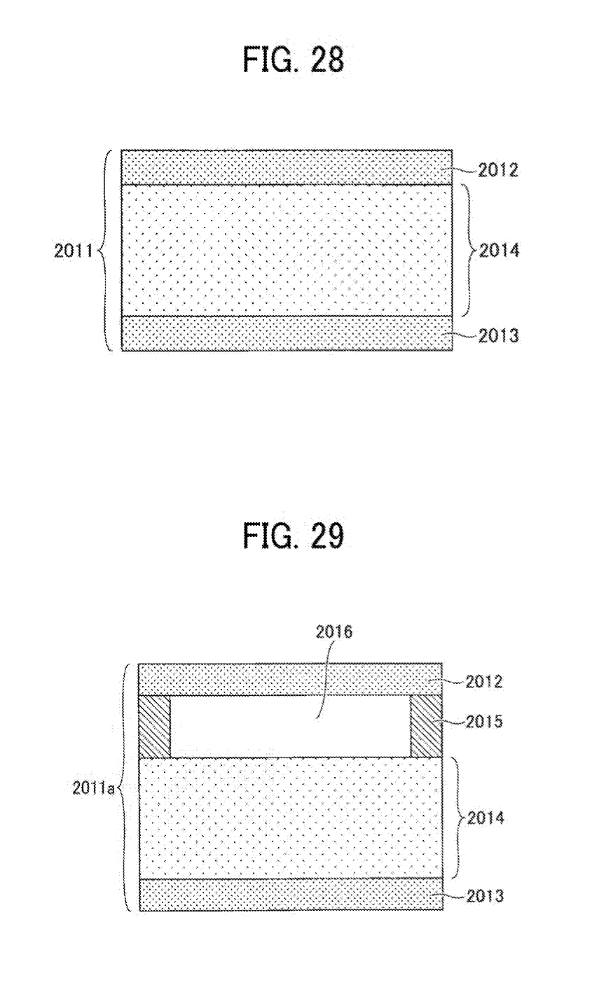

A description is given of examples of configurations of the energy convening device 201 with reference to FIGS. 28 to 34.

The electricity generation element of the energy converting device 201 includes, tor example, a first electrode, an intermediate layer, and a second electrode, which are stacked with this order. The intermediate layer is made of, for example, silicone rubber composition including silicone rubber. In this configuration, the peak intensity ratio (1095±5 cm⁻¹/1025±5 cm⁻¹) of the infrared (IR) absorption spectrum of the intermediate layer is set differently along the vertical direction (i.e., depth direction of the intermediate layer) with respect to the first electrode face and the second electrode face.

FIG. 28 illustrates an example of a schematic cross-sectional view of an electricity generation element 201.

### (Electricity Generation Element)

As illustrated in FIG. 28, the electricity generation element 2011 includes, for example, a first electrode 2012, an intermediate layer 2014, and a second electrode 2013, which are stacked with this order, and further includes other components as necessary.

### (First Electrode and Second Electrode)

Material, shape, size, and structure of the first electrode and the second electrode can be selected without any restriction, and the material, shape, size, and structure of the first electrode and the second electrode can be appropriately selected depending on the purpose.

As to the first electrode and the second electrode, the material, shape, size, and structure of the first electrode and the second electrode may be the same or different, and the material, shape, size, and structure of the first electrode and the second electrode may be preferably the same.

The material of the first electrode and the second electrode can be selected from, fur example, metal, carbon-based, conductive material, and conductive rubber composition.

The metal can be selected from, for example, gold, silver, copper, iron, aluminum, stainless steel, tantalum, nickel, and phosphor bronze.

The carbon based conductive material can be selected from, for example, graphite, carbon fiber, and carbon nanotube.

The conductive rubber composition can be a composition including, for example, a conductive filler and rubber.

The conductive filler can be selected from, for example, carbon material (Ketjen black, acetylene black, graphite, carbon fiber (CF), carbon nano fiber (CNF), carbon nanotube (CNT)), metal filler (gold, silver, platinum, copper, iron, aluminum, nickel), conductive polymer material (any one of derivatives of polythiophene, polyacetylene, polyaniline, polypyrrole, polyparaphenylene, and polyparaphenylenevinylene, or a derivative thereof added with dopant such as anion or cation, and ionic liquid. These, may be used alone, or two or more of them may be used in combination.

The rubber can be selected from, for example, silicone rubber, modified silicone rubber, acrylic rubber, chloroprene rubber, polysulfide rubber, urethane rubber, isobutyl rubber, fluoro silicone rubber, ethylene rubber, and natural rubber (latex). These may be used alone, or two or more of them may be used in combination.

The shape of the first electrode and the shape of the second electrode can be selected from, for example, sheet, film, thin film, woven fabric, non woven fabric, mesh, and sponge. Further, the shape of the first electrode and the shape of the second electrode can be made as nonwoven fabric formed by overlapping fibrous carbon material.

The shape of the last electrode and the shape of the second electrode is not particularly limited, but can be selected appropriately according to the shape of the electricity generation element.

The size of the first electrode and the size of the second electrode is not particularly limited, but can be selected appropriately according to the size of the electricity generation element.

The average thickness of the first electrode and the average thickness of the second electrode can be appropriately selected depending on the structure of the electricity generation element. From a view point of conductivity and flexibility, the average thickness of the first electrode and the average thickness of the second electrode are preferably from 0.01 μm to 1 mm, and more preferably from 0.1 μm to 500 μm. When the average thickness is 0.01 μm or more, the mechanical strength can be set appropriately, and the conductivity can be improved. Further, when the average thickness 1 mm or less, the electricity generation element can be deformable, and electricity generation performance can be improved.

### (Intermediate Layer)

The intermediate layer is made of for example, silicone rubber composition including silicone rubber. The peak intensity ratio (1005±5 cm⁻¹/1025±5 cm⁻¹) of the infrared (IR) absorption spectrum of the intermediate layer is set differently along the vertical direction (i.e., depth direction of the intermediate layer) with respect to the first electrode face and the second electrode face. Since the peak intensity ratio of the intermediate layer made of the silicone rubber composition becomes different along the depth direction of the intermediate layer, it can be estimated that the potential difference occurs between both ends of the intermediate layer in the depth direction when a distortion occurs to the intermediate layer, with which electricity can be generated.

In this configuration, the difference of the peak intensity ratio (1095±5 cm⁻¹/1025±5 cm⁻¹) is not limited to a particular value, but the difference of the peak intensity ratio can be set any value as long as the peak intensity ratio is different along the depth direction of the intermediate layer. Preferably, the intermediate layer includes portions having different peak intensity ratio, and the peak intensity ratio can be changed continuously or discontinuously. Further, any one of the peak intensity ratio of the intermediate layer at the first electrode side and the peak intensity ratio of the intermediate layer at the second electrode side can be set with a higher peak intensity ratio.

### (Measurement of Infrared (IR) Absorption Spectrum of Intermediate Layer)

The infrared (SR) absorption spectrum of the intermediate layer can be measured by cutting a sample piece from the intermediate layer, and analyzing the depth direction (i.e., cross section) of the sample piece by using a microscopic infrared spectrometer.

It is known that the silicone rubber has two absorption derived from Si—O—Si stretching vibration in the range of 1150 cm⁻¹ to 1000 cm⁻¹, in which the peak on the high wavenumber side is attributed to the symmetric stretching vibration, and the peak on the lower wavenumber side is attributed to the anti-symmetric stretching vibration (see “I. Soga, S. Granick, Macromolecules 1998, 31, 5450”).

In the embodiment, the absorption derived from the Si—O—Si stretching vibration of the silicone rubber is observed in the intermediate layer in the vicinity of 1095 cm⁻¹ and 1025 cm⁻¹, and further the peak intensity ratio (1095±5 cm⁻¹/1025±5 cm⁻¹) of the infrared (IR) absorption spectrum of the intermediate layer becomes different along the depth direction of the intermediate layer, which means that the intermediate layer includes portions having different Si—O—Si bond states of the silicone rubber, and when the distortion occurs so the intermediate layer having this structure, it is presumed that the potential difference occurs between both ends of the intermediate layer, and then electricity can be generated.

In the embodiment, any one of the peak intensity ratio (1095±5 cm⁻¹/1025±5 cm⁻¹) of the infrared(IR) absorption, spectrum at the position of 1 μm in the depth direction from the surface of the intermediate layer at the first electrode side, and the peak intensity ratio (1095±5 cm⁻¹/1025±5 cm⁻¹) of the infrared (IR) absorption spectrum at the position of 1 μm in the depth direction from the surface of the intermediate layer at the second electrode side becomes a smaller value or a greater value, and the rate of change of the peak intensity ratio is calculated by dividing the smaller peak intensity ratio by the greater peak intensity ratio. The rate of change of the peak intensity ratio is preferably 0.95 or less. When the rate of change of the peak intensity ratio is 0.95 or less, it can be determined that the peak intensity ratio becomes different, along the depth direction of the intermediate layer, and the intermediate layer includes portions having different Si—O—Si bond states of the silicotic rubber.

The peak intensity ratio (1095±5 cm⁻¹/1025±5 cm⁻¹) of the infrared (IR) absorption spectrum can be changed along the depth direction of the intermediate layer by, for example, modifying the surface of the intermediate layer, and adding a compound having silicon atom in the intermediate layer.

The intermediate layer is made of for example, silicone rubber composition.

The silicone rubber composition includes the silicone rubber, and preferably includes a filler, and further includes other components as necessary.

### (Silicone Rubber)

The silicone rubber is not particularly limited as long as the silicone rubber has an organopolysiloxane bond, and the silicone rubber can be appropriately selected depending on the purpose.

The silicone rubber can be selected from, for example, dimethyl silicone rubber, methylphenyl silicone rubber, modified silicone rubber (acrylic modified silicone rubber, alkyl modified silicone rubber, ester modified silicone rubber, epoxy modified silicone rubber). These may be used alone, or two or more of them may be used in combination.

The silicone rubber cast be appropriately synthesized, or the silicone rubber can use commercially available products. The commercially available products can be selected from, for example, IVS 4312, TSE 5033, XF14-C2042 (Momentive Performance Materials Japan, LLC), RE-1935 (manufactured by Shin-Etsu Chemical Co., Ltd.), and DY 35-2083 (manufactured by Dow Corning Toray Co., Ltd.). These may be used alone or in combination of two or more.

### (Filter)

The filler is not particularly limited, but the filler can be selected appropriately according to the purpose. The filler can be selected from, for example, organic filler, inorganic filler, and organic-inorganic composite filler. By including the filler, it is estimated that the capacitance of the intermediate layer changes even if the distortion is small, and the amount of electricity generation can be increased.

The organic filler can use any organic compound without particular limitation as long as it is organic compound.

The organic filler can be selected from, for example, acrylic fine particles, polystyrene particles, melamine particles, fluorine resin fine particles such as polytetrafluoroethylene, silicone powder (silicone resin powder, silicone rubber powder, silicone composite powder), rubber powder, wood flour, pulp, and starch.

The inorganic filler can be any inorganic material without particular limitation as long as it is inorganic compound.

The inorganic filler can be selected from, for example, oxides, hydroxides, carbonates, sulfates, silicates, nitrides, carbons, metals, or other compounds

The oxides can be selected from, for example, silica, diatomaceous earth, alumina, zinc oxide, titanium oxide, iron oxide, and magnesium oxide

The hydroxides can be selected from, for example, aluminum hydroxide, calcium hydroxide, and magnesium hydroxide.

The carbonates can be selected from, for example, calcium carbonate, magnesium carbonate, barium carbonate, and hydrotalcite.

The sulfates can be selected from, for example, aluminum sulfate, calcium sulfate, and barium sulfate.

The silicates can be selected from, for example, calcium silicate (wollastonite, zonotolite), zircon silicate, kaolin, tale, mica, zeolite, perlite, bentonite, montmoronite, sericite, activated clay, glass, and hollow glass beads.

The nitrides can be selected from, for example, aluminum nitride, silicon nitride, and boron nitride.

The carbons can be selected from, for example, Ketjen black, acetylene black, graphite, carbon fiber, carbon nanofiber, and carbon nanotube.

The metal can be selected from, for example, gold, silver, platinum, copper, iron, aluminum, and nickel.

The other compounds can be selected from, for example, potassium titanate, barium titanate, stronium titanate, lead zirconate titanate, silicon carbide, and molybdenum sulphide.

Further, the inorganic filler can be processed with the surface treatment.

The organic-inorganic composite filler can be used without particular limitation as long as the organic-inorganic composite is a compound combining an organic compound and an inorganic compound at the molecular level.

The organic-inorganic composite filler can be selected from, for example, silica-acrylic composite fine particles, and silsesquioxane.

Among the fillers, a compound having a silicon atom is preferred because it can increase the amount of electricity generation by adding the compound having the silicon atom.

The compound having the silicon atom can be selected from, for example, silica, diatomaceous earth, silicate (calcium silicate (wollastonite, zonotolite), zircon silicate. kaolin, talc, mica, zeolite, perlite, bentonite, montmoronite, sericite, activated clay, glass, hollow glass beads), silicone powder (silicone resin powder, silicone rubber powder, silicone composite powder), silica/acrylic composite fine particles, silsesquioxane. Among these, silica, kaolin, talc, wollastonite, silicone powder and silsesquioxane are preferable from the viewpoint of electricity generation performance

The silica can be selected from, for example, Sisilia 430 (manufactured by Fuji Silicia Co., Ltd.), and HS-207 (manufactured by Nippon Steel Sumikin Materials Co., Ltd.).

The kaolin can be selected from, for example, ST-100, ST-KE, ST-CROWN (manufactured by Shiraishi Calcium Co., Ltd.), RC-1, Giomax LL, Satintone No. 5 (manufactured by Takehara Kagaku Kogyo Co., Ltd.).

The talc can be selected from, for example, JM-209, JM-309 (manufactured by Asada Milling Co., Ltd.), P talc, PH tale, micro-light, high-micron HE5 (manufactured by Takehara Kagaku Kogyo Co., Ltd.), and D-1000, D-800, SG-95, P-3 (manufactured by Nippon Talc Co., Ltd.).

The mica can be selected from, for example, A-11 (manufactured by Yamaguchi Mica Co., Ltd.), PDM-5B (manufactured by Topy Industries, Ltd.).

The wollastonite can be selected from, for example, Wallast JET 30w, Wallast 325 (manufactured by Asada Flour Milling Co., Ltd.), ST-40 F (Shiraishi Calcium Co., Ltd.).

The zeolite can be selected from, for example, SP #2300, SP #600 (manufactured by Nitto Powder Industry Co., Ltd.).

The barium titanate can be selected from, for example, 208108 (manufactured by ALDRICH).

The strontium titanate can be selected from, for example, 396141 (manufactured by ALDRICH).

The sericite can be selected front, for example, ST-501 (manufactured by Shiraishi Calcium Co., Ltd.).

The diatomite can be selected from, for example, CT-C 499 (manufactured by Shiraishi Calcium Co., Ltd.).

The hollow glass beads can be selected from, for example, Sphericel 110P8 (manufactured by Potters Ballotini).

The acrylic fine particles can be selected from, for example, FH-S005 (manufactured by Toyobo Co., Ltd.).

The polystyrene fine particles can be selected from, for example, 19520-500 (manufactured by TECHNO CHEMICAL Co., Ltd.).

The silicone resin powder can be selected from, for example, Tospearl 120 (manufactured by Momentive Performance Materials Japan, LLC), KMP-590 (manufactured by Shin-Etsu Chemical Co., Ltd.).

The silicone rubber powder can be selected from, for example, EP-2600 (manufactured by Dow Corning Toray Co., Ltd.), KMP-597 (manufactured by Shin-Etsu Chemical Co., Ltd.).

The silicone composite powder can be selected from, for example, KMP-605, X-52-7030 (manufactured by Shin-Etsu Chemical Co., Ltd.).

The silica/acrylic composite fine particles can be selected from, for example. Solio Star RA (manufactured by Nippon Shokubai Co., Ltd.).

The silsesquinoxane can be selected from, for example, PPS-octamethyl substituted 526835, PPS-octaphenyl substituted 526851, PPS-octavinyl substituted 475424 (manufactured by ALDRICH).

The mean particle size of the filler is not particularly limited, and can be appropriately selected depending on the purpose. The mean particle size of the filler is preferably from 0.01 μm to 30 μm, and more preferably from 0.1 μm to 10 μm. When the mean particle size of the filler is 0.01 μm or more, the electricity generation performance can be increased. Further, when the mean particle size of the filler is 30 μm or less, the intermediate layer has good flexibility and the electricity generation performance can be increased.

The mean particle size can be measured according to a known method using a known particle size distribution measuring apparatus, for example, Microtrac HRA (manufactured by Nikkiso Co., Ltd.).

The content rate of the filter is preferably from 0.1 parts by mass to 100 parts by mass, and more preferably from 1 part by mass to 50 parts by mass with respect to 100 parts by mass of the silicone rubber. When the content, rate is 0.1 part by mass or more, the electricity generation performance can be increased. Further, when the content rate is 100 parts by mass or less, the intermediate layer has good flexibility, and the electricity generation performance can be increased.

### (Other Components)

The other components are not particularly limited, and can be selected appropriately according to the purpose. The other components are for example, rubber, and additives. The content rate of the components can be appropriately selected within a given rate that does not impair the purpose of the above described embodiments.

The rubber can be selected from, for example, fluoro silicone rubber, acrylic rubber, chloroprene rubber, natural rubber (latex), methane rubber, fluorine rubber, and ethylene propylene rubber.

The additive can be selected from, for example, crosslinking agent, deterioration inhibitor, heal resistance agent, and coloring agent.

### (Preparation of Silicone Rubber Composition)

The silicone rubber composition can be prepared by mixing the silicone rubber and the filler, and if necessary, other components, and then the silicone rubber composition can be prepared by kneading and dispersing these materials.

### (Formation of Intermediate Layer)

The method of forming the intermediate layer can be appropriately selected depending on the purpose without any restriction. For example, the intermediate layer can be made by applying the silicone rubber composition on a substrate by using the blade coating, die coating, and dip coating, and then curing the silicone rubber composition by applying heat, an electron beam or the like.

The intermediate layer can be a single layer or multiple layers.

The average thickness of the intermediate layer is not particularly limited, and can be selected appropriately according to the purpose. The average thickness of the intermediate layer is preferably from 1 μm to 10 mm, more preferably from 20 μm to 200 μm. When the average thickness of the intermediate layer is 1 μm or more, the mechanical strength can be appropriate and the electricity generation performance can be improved. When the average thickness of the intermediate layer is 10 mm or less, the flexibility of the intermediate layer is good and the electricity generation performance can be improved.

As to the electrical characteristics of the intermediate layer, the intermediate layer preferably has the insulating properties. As to the insulating property, it is preferable to have a volume resistivity 108 Ωcm or more, and more preferably have a volume resistivity of 1010 Ωcm or more. The electricity generation performance can be increased by setting the volume resistivity of the intermediate layer to a preferable numerical range.

### (Surface Modification Treatment of Intermediate Layer)

The intermediate layer is preferably subjected to the surface modification treatment.

The surface reforming or modification treatment is not particularly limited, and can be appropriately selected according to the purpose as long as the surface reforming or modification treatment has a certain degree of irradiation energy and can modify material. For example, a plasma treatment, a corona discharge treatment, an electron beam irradiation treatment, an ultraviolet irradiation treatment, an ozone treatment, and a radiation (X ray, α ray, β ray, γ ray, neutron ray) irradiation treatment can be used as the surface reforming or modification treatment. Among them, from the viewpoint of processing speed, it is preferable to use the plasma treatment, the corona discharge treatment, and the electron beam irradiation treatment.

### (Plasma Treatment)

In the case of the plasma treatment, a plasma generating apparatus can use, for example, a parallel plate type, a capacitive coupling type, an inductive coupling type as well as an atmospheric pressure plasma apparatus. From the viewpoint of durability, the reduced pressure plasma treatment is preferable.

The reaction pressure in the plasma treatment is not particularly limited, and can be appropriately selected according to the purpose. The reaction pressure in the plasma treatment is preferably from 0.05 Pa to 100 Pa, and more preferably from 1 Pa to 20 Pa.

The reaction atmosphere in the plasma treatment is not particularly limited, and can be appropriately selected according to the purpose. For example, gases such as inert gas, noble gas, and oxygen are effective. From the viewpoint of the sustainability of effect, argon is preferable. Further, it is preferable to set the oxygen partial pressure to 5,000 ppm or less. When the oxygen partial pressure in the reaction atmosphere is 5,000 ppm or less, the ozone generation cart be suppressed, and thereby the use of an ozone treatment apparatus can be reduced or omitted.

The irradiation power amount in the plasma treatment is defined by “output×irradiation time.” The irradiation power amount is preferably from 5 Wh to 200 Wh, and more preferably from 10 Wh to 50 Wh. When the irradiation power amount is within a preferable range, the intermediate layer can be set with the electricity generation capability, and the durability decrease caused by the excessive irradiation can be prevented.

### (Corona Discharge Treatment)

The applied energy (cumulative energy) in the corona discharge treatment is preferably from 6 J/cm² to 300 J/cm², and more preferably from 12 J/cm² to 60 J/cm². When the applied energy is within a preferable range, the electricity generation performance and durability of the intermediate layer can be enhanced.

The applied voltage in the corona discharge treatment is preferably from 50 V to 150 V, and more preferably 100 V. The reaction atmosphere of the corona discharge treatment is preferable air

### (Electron Beam Irradiation Treatment)

The irradiation amount in the electron beam irradiation treatment is preferably 1 kGy or more, and more preferably from 300 kGy to 10 MGy. When the irradiation amount is within a preferable range, the intermediate layer can be set with the electricity generation capability, and the durability decrease caused by the excessive irradiation can be prevented.

The reaction atmosphere in the electron beans irradiation treatment is not particularly limited, and can be appropriately selected according to the purpose. The reaction atmosphere in the electron beam irradiation treatment is preferably filled with an inert gas such as argon, neon, helium, and nitrogen, and the oxygen partial pressure is preferably 5,000 ppm or less. When the oxygen partial pressure in the reaction atmosphere is 5,000 ppm or less, the ozone generation can be suppressed and thereby the use of an ozone treatment apparatus can be reduced or omitted.

### (UV Irradiation Treatment)

The ultraviolet ray in the ultraviolet irradiation treatment is preferably has a wavelength range of 200 nm 365 nm, and more preferably a wavelength range of 240 nm to 320 mm.

The accumulated light intensity in the ultraviolet irradiation treatment is preferably from 5 J/cm² to 500 J/cm², and more preferably from 50 J/cm² to 400 J/cm². When the accumulated light intensity in the ultraviolet irradiation treatment is within a preferable range, the intermediate layer can be set with the electricity generation capability, and the durability decrease caused by the excessive irradiation can be prevented.

The reaction atmosphere in the ultraviolet irradiation treatment is not particularly limited, and can be appropriately selected according to the purpose. The reaction atmosphere in the ultraviolet irradiation treatment is preferably filled with an inert gas such as argon, neon, helium, and nitrogen, and the oxygen partial pressure is preferably 5,000 ppm or less. When the oxygen partial pressure in the reaction atmosphere is 5,000 ppm or less, the ozone generation can be suppressed and thereby the use of an ozone treatment apparatus can be reduced or omitted.

As conventional techniques, it has been proposed to form active groups by excitation or oxidation by using the plasma treatment, corona discharge treatment, ultraviolet irradiation treatment, electron beam irradiation treatment or the like to increase the interlayer adhesion performance. However, these techniques are limited to the application between layers, and it is known that the application of these techniques to the outermost surface is not favorable because these techniques lower releasability. Further, in another technique, the reaction is carried out in an oxygen-rich state and the reactive group (hydroxyl group) is effectively introduced into the surface of the substrate. These conventional technologies are different from the surface modification treatment in the embodiment.

In this disclosure, when the surface reforming or modification process is performed under the reduced pressure reaction environment such as reduced pressure reaction environment having lesser oxygen (e.g., plasma treatment), the surface reforming or modification process can promote re-crosslinking and bonding on the surface, in which, for example, the durability can be improved due to the increase of Si—O bond having higher binding energy, and further, the releasability can be improved due to the densification due to the increased crosslinking density.

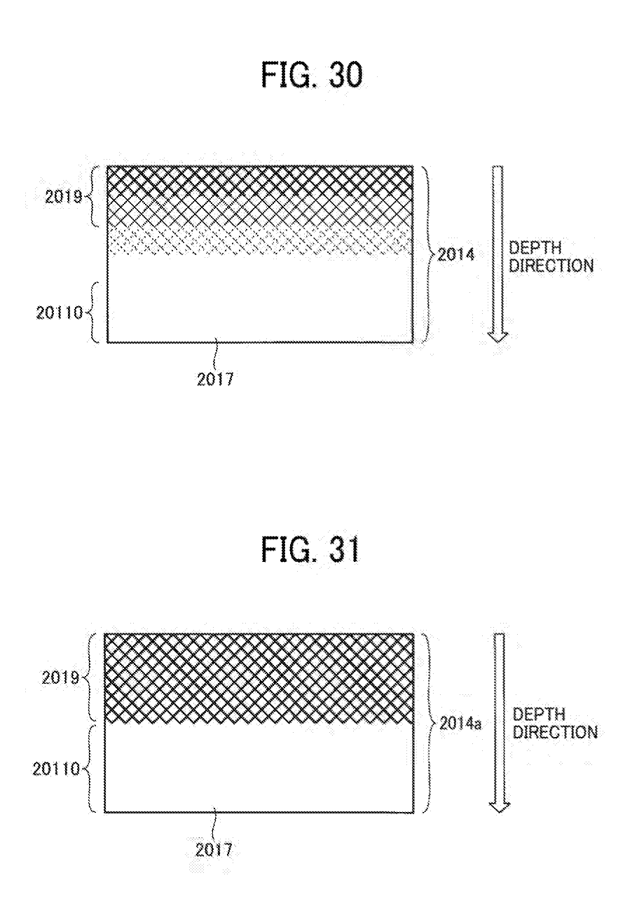

FIG. 30 illustrates an example of a schematic enlarged cross-sectional view of a micro structure of an intermediate layer 2014 configuring the electricity generation element of the above described embodiments. As illustrated in FIG. 30, the intermediate layer 2014 includes a first portion 2019 where the peak intensity ratio of the intermediate layer is small, and a second portion 20110 where the peak intensity ratio of the intermediate layer is great.

The intermediate layer 2014 includes a silicone rubber composition 2017 including the silicone rubber. As to the intermediate layer 2014, the peak intensity ratio (1095±5 cm⁻¹/1025±5 cm⁻¹) of the infrared (IR) absorption spectrum of the intermediate layer is set differently along the vertical direction (i.e., depth direction of the intermediate layer) with respect to the first electrode face and the second electrode face.

As to the intermediate layer 2014 of FIG. 30, the peak intensity ratio of the intermediate layer 2014 continuously changes from the first portion 2019 where the peak intensity ratio of the intermediate laser is small to the second portion 20110 where the peak intensity ratio of the intermediate layer is great.

FIG. 31 illustrates another example of a schematic enlarged cross-sectional view of a micro structure of the micro structure of an intermediate layer 2014a configuring the electricity generation element of the above described embodiments.

As illustrated FIG. 31, the intermediate layer 2014a includes a silicone rubber composition 2017 including silicone rubber. As to the intermediate layer 2014a, the peak intensity ratio (1095±5 cm⁻¹/1025±5 cm⁻¹) of the infrared (IR) absorption spectrum of the intermediate layer is set differently along the vertical direction (i.e., depth direction of the intermediate layer) with respect to the first electrode face and the second electrode face.

As to the intermediate layer 2014a of FIG. 31, the peak intensity ratio of the intermediate layer 2014 discontinuously changes from the first portion 2019 where the peak intensity ratio of the intermediate layer is small to the second portion 20110 where the peak intensity ratio of the intermediate layer is great at a boundary of the first portion 2019 and the second portion 20110.

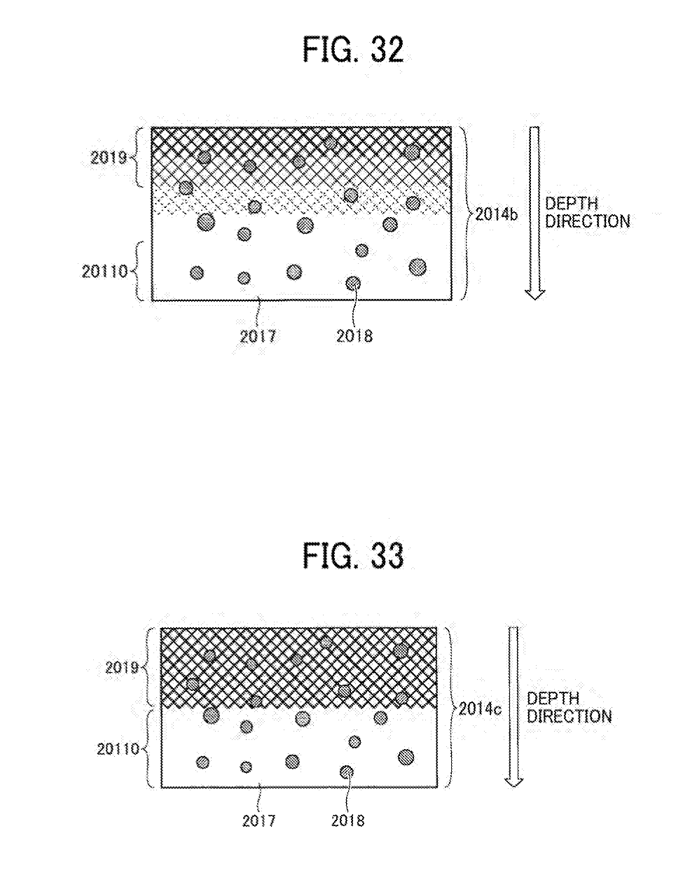

FIG. 32 illustrates another example of a schematic enlarged cross-sectional view of a micro structure of the micro structure of an intermediate layer 2014b configuring the electricity generation clement of the above described embodiments.

As illustrated in FIG. 32, the intermediate layer 2014b includes the silicone rubber composition 2017 including the silicone rubber, and a filler 2018.

As to the intermediate layer 2014b, the peak intensity ratio (1095±5 cm⁻¹/1025±5 cm⁻¹) of the infrared (SR) absorption spectrum of the intermediate layer is set differently along the vertical direction (i.e., depth direction of the intermediate layer) with respect to the first electrode face and the second electrode face.

As to the intermediate layer 2014b of FIG. 32, the peak intensity ratio of the intermediate layer 2014 continuously changes from the first portion 2019 where the peak intensity ratio of the intermediate layer is small to the second portion 30110 where the peak intensity ratio of the intermediate layer is great.

The filler 2018 can be uniformly dispersed in the intermediate layer 2014b. Further, the filler 2018 can be unevenly dispersed in the intermediate layer 2014b, in which the filler 2018 can be dispersed only in the first portion 2019 where the peak intensity ratio of the intermediate layer is small, or the filler 2018 can be dispersed only in the second portion 20110 where the peak intensity ratio of the intermediate layer is great.

FIG. 33 illustrates another example of a schematic enlarged cross-sectional view of a micro structure of the micro structure of an intermediate layer 2014c configuring the electricity generation element of the above described embodiments.

As illustrated in FIG. 33, the intermediate layer 2014c include the silicone rubber composition 2017 including the silicone rubber, and the filler 2018.

As to the intermediate layer 2014c, the peak intensity ratio (1095±5 cm⁻¹/1025±5 cm⁻¹) of the infrared (IR) absorption spectrum of the intermediate layer is set differently along the vertical direction (i.e., depth direction of the intermediate layer) with respect to the first electrode face and the second electrode face.

As to the intermediate layer 2014c of FIG. 33, the peak intensity ratio of the intermediate layer 2014 discontinuously changes from the first portion 2019 where the peak intensity ratio of the intermediate layer is small to the second portion 20110 where the peak intensity ratio of the intermediate layer is great at the boundary of the first portion 2019 and the second portion 20110.

The filler 2018 can be uniformly distributed in the intermediate layer 2014c. Further, the filler 2018 can be unevenly dispersed in the intermediate layer 2014c, in which the filler 2018 can be dispersed only in the first portion 2019 where the peak intensity ratio of the intermediate layer is small, or the filler 2018 can be dispersed only in the second portion 20110 where the peak intensity ratio of the intermediate layer is great.

(Gap space)

It Is preferable that the electricity generation element has a gap space between the intermediate layer and at least any one of the first electrode and the second electrode. By setting the gap space, even if the oscillation is weak, the capacitance of the electricity generation element can be changed, and the amount of electricity generation can be increased.

From the view point of the efficient electricity generation performance, a face of the intermediate layer where the peak intensity ratio (1095±5 cm⁻¹/1025±5 cm⁻¹) of the infrared (IR) absorption spectrum is small is preferably faced to the gap space.

The method of setting the space is not particularly limited, and can be appropriately selected according to the purpose. For example, a spacer can be disposed between the intermediate layer and any one of the first electrode and the second electrode.

### (Spacer)

The material, form, shape, and size of the spacer are not particularly limited, and the material, form, shape, and size of the spacer can be appropriately selected depending on the purpose.

The material of the spacer can be selected from, for example, polymeric materials, rubber, metal, conductive polymer material, and conductive rubber composition.

The polymer material can be selected from, for example, polyethylene, polypropylene, polyethylene terephthalate, polyvinyl chloride, polyimide resin, fluoro resin, and acrylic resin.

The rubber can be selected from, for example, silicone rubber, modified silicone rubber, acrylic rubber, chloroprene rubber, polysulfide rubber, urethane rubber, isobtuyl rubber, fluoro silicone rubber, ethylene rubber, and natural rubber (latex).

The metal can be selected from, for example, gold, silver, copper, aluminum, stainless steel, tantalum, nickel, and phosphor bronze.

The conductive polymer material can be selected from, for example, polythiophene, polyacetylene, and polyaniline.

The conductive rubber composition can be a composition including, for example, a conductive filler and rubber. The conductive filler can be selected from, for example, carbon material (Ketjen black, acetylene black, graphite, carbon fiber (CF), carbon nano fiber (CNF), carbon nanotube (CNT)), metal filler (gold, silver, platinum, copper, iron, aluminum, nickel), conductive polymer material (any one of derivatives of polythiophene, polyacetylene, polyaniline, polypyrrole, polyparaphenylene, and polyparapbenylenevinylene, or a derivative thereof added with dopant such as anion or cation, and ionic liquid. These may be used alone, or two or more of them may be used in combination.

The rubber can be selected from, for example, silicone rubber, modified silicone rubber, acrylic rubber, chloroprene rubber, polysulfide rubber, urethane rubber, isobutyl rubber, acrylic silicone rubber, ethylene rubber, and natural rubber (latex).

The form of the spacer can be selected from, for example, sheet, film, woven fabric, nonwoven fabric, mesh, and sponge.

The shape, size, thickness and disposing position of the spacer can be selected appropriately according to the structure of the electricity generation element.

The intermediate layer preferably has no initial surface potential in a stationary state.

The initial surface potential of the intermediate layer in the stationary state can be measured under the following measurement conditions. In this disclosure, the intermediate layer has no initial surface potential means that the surface potential of the intermediate layer becomes within ±10V range when the surface potential is measured under the following measurement conditions.

### (Measurement Conditions)

Pretreatment: after standing for 24 hours in an atmosphere having a temperature of 30° C. and a relative humidity of 40%, the static elimination was carried out for 60 seconds using SJ-F 300 manufactured by Keyence Corporation.

Apparatus: Treck Model 344

Measuring probe: 6000 B-7C

Measurement distance: 2 mm

Measurement spot diameter: diameter (Φ) of 10 mm.

It can be estimated that the intermediate layer having not initial surface potential can generate power differently compared to conventional technologies.

As to the electricity generation element of the above described embodiments, the electricity generation element deforms when a load such as external force or vibration is applied to the electricity generation element, and then the electricity generation element generates electricity. When the load is applied to the electricity generation element, a portion of the intermediate layer in the vicinity of the electrode is charged by a mechanism similar to triboelectric charging, or electric charges are generated inside the intermediate layer, with which a surface potential difference occurs for the intermediate layer. It can be estimated that electric charges move in a direction so that the surface potential difference becomes zero, and then electricity is generated.

FIG. 28 illustrates an example of a schematic cross-sectional view of the electricity generation element of the above described embodiments. As illustrated in FIG. 28, the electricity generation element 2011 includes, for example, a pair of electrodes such as a first electrode 2012 and a second electrode 2013, and the intermediate layer 2014.

Further, FIG. 29 illustrates another example of a schematic cross-sectional view of the electricity generation element of the above described embodiments. As illustrated FIG. 29, the electricity generation element 2011 includes a spacer 2015 between the first electrode 2012 and the intermediate layer 2014 to set a gap space 2016. By setting the gap space 2016 as illustrated in FIG. 29, the electricity generation element 2011 can be deformed easily.

Further, the gap space 2016 can be disposed between the first electrode 2012 and the intermediate layer 2014 alone, the gap space 2016 can be disposed between the second electrode 2013 and the intermediate layer 2014 alone, or the gap space 2016 can be disposed between the first electrode 2012 and the intermediate layer 2014 and also between the second electrode 2013 and the intermediate layer 2014.

### (Energy Converting Device)

The energy converting device 201 of the above described embodiment includes at least the electricity generation element of the above described embodiments, and further includes other components as necessary. Since the energy concerting device 201 employs the electricity generation element of the above described embodiments, the energy converting device 201 does not require a high voltage application during an operation.

As to the energy convening device 201 of the above described embodiments, the electricity generation element deforms when a load such as external force or vibration is applied to the electricity generation element, and then the electricity generation element generates electricity. Although the electricity generation mechanism is not yet fully researched, when the load is applied to the electricity generation element, a portion of the intermediate layer in the vicinity of the electrode is charged by a mechanism similar to triboelectric charging, or electric charges are generated inside the intermediate layer. When the electricity generation element deforms under tins condition, the capacitance of the intermediate layer changes, with which a surface potential difference occurs for the intermediate layer. It can be estimated that electric charges move in a direction so that the surface potential difference becomes zero, and then electricity is generated.

### (Other Components)

The other components can be, for example, a cover, an electric wire, and an electric circuit.

### (Cover Material)

The cover material is not particularly limited, and can be selected appropriately according to the purpose.

The material of the cover can be selected from, for example, polymer material, and rubber. The polymer material can be selected from, for example, polyethylene, polypropylene, polyethylene terepthalate, polyvinyl chloride, polyimide resin, fluoro resin, and acrylic resin. The rubber can be selected from, for example, silicone rubber, modified silicone rubber, acrylic rubber, chloroprene rubber, polysulfide rubber, urethane rubber, isobutyl rubber, fluoro silicone rubber, ethylene rubber, and natural rubber (latex).

The configuration, shape, size, and thickness of the cover material are not particularly limited, and can be selected appropriately according to the energy converting device.

### (Electrical Wire)

The electric wire is not particularly limited, and can be selected appropriately according to the purpose.

The material of the electric wire can be selected from, for example, metal, and alloy. The metal can be selected from, for example, gold, silver, copper, aluminum, and nickel.

The configuration, shape, and thickness of the electric wire are not particularly limited, and can be selected appropriately according to the energy converting device.

### (Electric Circuit)

The electric circuit is not particularly limited, and can be selected appropriately according to the purpose as long as the electric circuit can extract electric power generated by the electricity generation element.

The electric circuit can be selected from, for example, a rectifier circuit, an oscilloscope, a voltmeter, an ammeter, a storage circuit, and a light emitting diode (LED), and various sensors such as a ultrasonic sensor, a pressure sensor, a tactile sensor, a strain sensor, an acceleration sensor, an impact sensor, a vibration sensor, a pressure-sensitive sensor, an electric field sensor, and a sound pressure sensor.

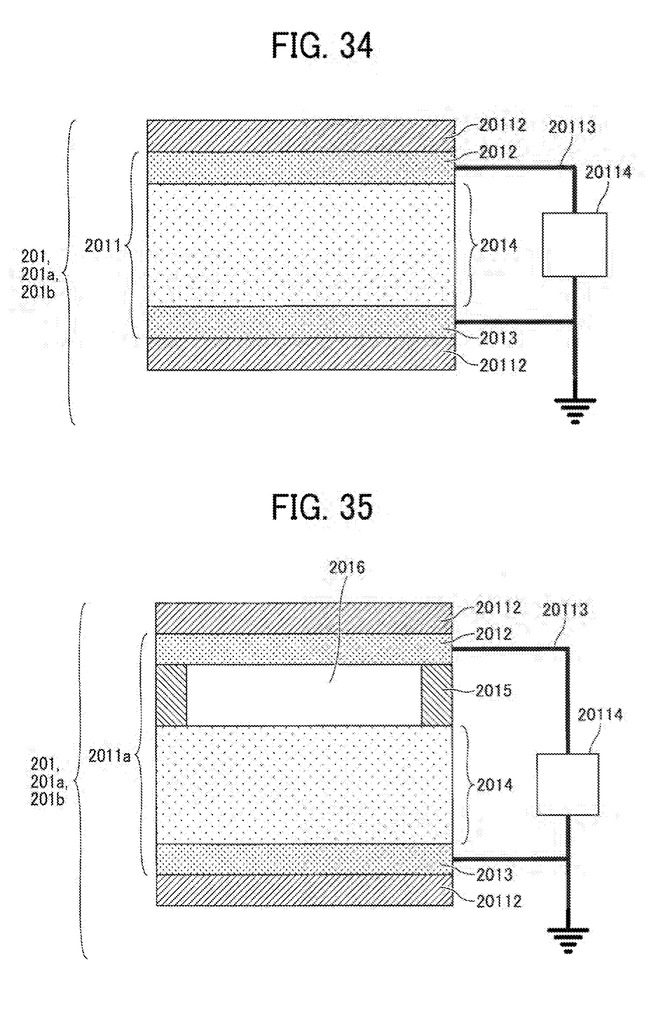

FIG. 34 illustrates an example of a schematic cross-sectional view of the energy converting device 201 of the above described embodiments. As illustrated in FIG. 34, the energy converting device 201 includes, for example, an electricity generation element 2011, a cover 20112, an electric wire 20113, and an electric circuit 20114.

Further, FIG. 35 illustrates another example of a schematic cross-sectional view of an energy converting device 201 of the above described embodiments. As illustrated in FIG. 35, the energy converting device 201 includes, for example, the electricity generation element 2011, the cover 20112, the electric wire 20113, the electric circuit 20114, and the electricity generation element 2011 of the energy convening device 201 includes a gap space 2016. By setting the gap space 2016 as illustrated in FIG. 35, the electricity generation element 2011 can be deformed easily. Therefore, even if the oscillation is weak, the capacitance of the electricity generation element can be changed, and the amount of electricity generation can be increased.

As to the above described energy convening device 201 of the above described embodiments, a human body can be used as the antenna to receive electromagnetic (EM) noise, and the received electromagnetic (EM) noise can be detected. Further, as to the above described energy converting device 201 of the above described embodiments, the energy converting device 201 can perform higher electricity generation performance, with which no external power supply is necessary. Further, as to the above described energy converting device 201 of the above described embodiments, the energy converting device 201 has excellent flexibility, with which the energy converting device 201 can be disposed at a seat.

Further, conventional methods using conventional piezoelectric element cannot detect the electromagnetic (EM) noise although the electromagnetic (EM) noise can be received by a human body (organic body) functionable as the antenna. Further, conventional piezoelectric element such as ceramic-based piezoelectric element is not flexible and fragile. Further, when the electromagnetic (FM) noise is detected based on the resistance change of a conductive rubber as disclosed as conventional technologies, electricity is not generated, and thereby conventional piezoelectric element cannot be installed in places where external power sources are required.

The energy converting device 201 of the above described embodiments is not limited to the above examples. For example, the energy converting device 201 can be any device that can detect the electromagnetic (EM) noise by using the human body as the antenna to receive the electromagnetic (FM) noise. Further, the energy converting device 201 can be configured with any sensor that outputs a signal equal to or larger than a threshold when a person or an object is on or over the censor such as conventional piezoelectric elements.

Further, the above-described system configuration is just an example. The system configuration can be changed variously depending on the use and purpose.

Further, the information processing apparatus 10 can be configured by two or more one or more computers, in which the information processing apparatus 10 can be configured by cloud computing.

Further, a part of the function of the information processing apparatus 10 can be set in the detection apparatuses 20 and 20a. For example, the determination unit 12 can be configured in the detection apparatus 20, in which the determination unit 12 can be implemented by a semiconductor integrated circuit such as an field programmable gate array (FPGA) and an application specific integrated circuit (ASIC).

According to the above disclosed embodiments, the behavior of person such as an action of a person in the three dimensional space can be directly detected and monitored. Further, although the above disclosed embodiments is employed for seats in a hall as an example of the three dimensional space, but not limited thereto. For example, the three dimensional space can be an open space such as a park, a semi-open or close place such as a stadium, and a closed space such as vehicle, ship, and airplane. Further, although the above disclosed embodiments use the second energy convening device 201b (i.e., second piezoelectric element) with the first energy converting device 201a (i.e., first piezoelectric element), the second energy converting device 203b (i.e., second piezoelectric element) alone can be disposed for the detection apparatus depending on the needs of the behavior management system.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

As described above, the present invention can be implemented in any convenient form, for example using dedicated hardware, or a mixture of dedicated hardware and soft ware. The present invention may be implemented as computer software implemented by one or more networked processing apparatuses, live network can comprise any conventional terrestrial or wireless communications network, such as the Internet. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

What is claimed is:

1. A behavior management system comprising:
one detection apparatus including at least one piezoelectric element disposed at a place where the piezoelectric element receives an effect of an action of a person; and
circuitry to:
detect a voltage output from the piezoelectric element when the piezoelectric element is applied with force caused by the action of the person;
determine a level of the action of the person at the place based on a change of amplitude and polarity of the detected voltage; and
output information associated to the determined level of the action of the person.

2. The behavior management system of claim 1, wherein the circuitry determines the level of the action of the person based on a changing pattern of the polarity of the detected voltage along a time line.

3. The behavior management system of claim 1,
wherein the piezoelectric element includes a first piezoelectric element disposed for receiving a first type effect from the person, and a second piezoelectric element disposed for receiving a second type effect from the person,
wherein when the second piezoelectric element outputs a voltage corresponding to electromagnetic noise, received by the second piezoelectric element through the person functioning as an antenna as the second type effect, the circuitry detects the voltage output from the second piezoelectric element, and determines whether the voltage output from the second piezoelectric, element is equal to or greater than a givers threshold, and when the circuitry determines that the voltage output from the second piezoelectric element is equal to or greater than the given threshold, the circuitry outputs a voltage pattern output and received from the first piezoelectric element as the first type effect.

4. The behavior management system of claim 3, wherein when the circuitry receives a voltage pattern output from the first piezoelectric element alone, and detects that a voltage of the voltage pattern output from the first piezoelectric element is equal to or greater than a given threshold, the circuitry outputs the voltage pattern output and received from the first piezoelectric element as the first type effect.

5. The behavior management system of claim 1, further comprising another detection apparatus in addition to the one detection apparatus,
wherein the circuitry calculates a score based on a voltage pattern output from the one detection apparatus, and a score based a voltage pattern output from the another detection apparatus, the score indicating a danger level of the action of the person, and the circuitry determines whether the action of the person is a dangerous action based on the score calculated from the voltage pattern output from the one detection apparatus, and the score calculated from the voltage pattern output from the another detection apparatus.

6. The behavior management system of claim 5,
wherein the one detection apparatus is disposed at one seat set in a three dimensional space, and the another detection apparatus is disposed at another seat set in the three dimensional space,
wherein the circuitry sets a weight for the score calculated for the voltage pattern output from the another detection apparatus based on a relative positional relationship of the one seat disposed with the one detection apparatus and the another seat disposed with the another detection apparatus in the three dimensional space, or based on a position of the another seat disposed with the another detection apparatus set in the three dimensional space.

7. A method of monitoring behavior of a person:
receiving an effect of an action of the person present at a place by using a piezoelectric element disposed at the place;
detecting a voltage output from the piezoelectric element, when the piezoelectric element is applied with force caused by the action of the person;
determining a level of the action of the person at the place based on a change of amplitude and polarity of the detected voltage; and
outputting information associated to the determined level of the action of the person.

8. An information processing apparatus comprising:
circuitry to:
detect a voltage output from a detection apparatus including a piezoelectric element disposed at a place where a person is present, when the piezoelectric element is applied with force caused by an action of the person;
determine a level of the action of the person at the place based on a change of amplitude and polarity of the detected voltage; and
output information associated to the determined level of the action of the person.
